(19) United States
(12) Patent Application Publication
(10) Pub. No.: US 2004/0186746 A1
(43) Pub. Date: Sep. 23, 2004

(54) System, apparatus and method for storage and transportation of personal health records

(76) Inventors: Wendy P. Angst, Wilmington, DE (US); Jennifer R. Hurter, Toney, AL (US); Judy S. Denton, Huntsville, AL (US); Ira C. Denton, Huntsville, AL (US)

Correspondence Address: HUNTLEY & ASSOCIATES, 1105 NORTH MARKET STREET, P.O. BOX 948, WILMINGTON, DE, 19899-0948, US

(21) Appl. No.: 10/393,751

(22) Filed: Mar. 21, 2003

(51) Int. Cl. G06F 17/60; H04L 9/00; H04L 9/32; G06F 11/30; G06F 12/14

(52) U.S. Cl. 705/3; 713/201

(57) ABSTRACT

A system and process for storing, managing transporting and communicating personal health and medical information

### BACKGROUND OF THE INVENTION

The present invention relates generally to the field of electronic medical records, particularly to a computer-implemented system and method for the secure transportation, storage, management and communication of individual health and medical records. Specifically, the invention relates to the user's personal management of said medical records and the memory device for storing, consolidating and making said medical records transportable.

Although many people do not, it is wise for a patient to keep paper medical records or store medical files on the hard drive of a home computer or other computerized mechanism. Such files can supply the information needed to participate in one's own medical care. In an emergency, they enable a patient to quickly provide doctors details of hospitalizations, medications, copies of X-rays and electrocardiograms, and warnings about drug allergies or interactions. They can also provide an extra measure of security against needless mistakes.

Today, to the extent they exist, most electronic medical records are maintained by physicians, but not by users. Collecting medical records in electronic format ensures users that all such records will be in one place. Most people assume that all the essential medical information will be recorded in their medical records, and that as they visit health care providers, all such information will be available to them. Unfortunately, this assumption is increasingly incorrect.

The storage, management, retrieval, and communication of an individual's medical information has been problematic for many years. This information is recorded and stored in a variety of formats at a variety of sites. There is no longer one doctor providing complete user care. Health and medical information is dispersed among multiple physicians, ancillary providers, hospitals, lab companies, pharmacies, insurers, and health clubs to name but a few. Individuals are increasingly seeking non-traditional forms of medicine, purchasing over-the-counter medication, and are called upon to play a more active role in personal health management and prevention. Thus, retrieval of an individual's medical record can be a lengthy process. Just to retrieve a paper-based record within the treating hospital can sometimes take over 24 hours.

These facts are known to have led to many tragic errors and the performance of expensive and unnecessary procedures. Until recently most medical records were kept in paper based files, but over the past few years there have been countless attempts to computerize these records. All such attempts have met with the difficulties described above regarding the proliferation of information among different sources, with different system architectures unable to seamlessly interface. Now such attempts must also deal with new legislation that requires the safeguarding of user information while demanding the portability of such information.

The Health Insurance Portability & Accountability Act of 1996 (August 21) (HIPAA), Public Law 104-191, which amends the Internal Revenue Service Code of 1986 mandates that all healthcare providers, health plans, payers, clearinghouses, and other entities that process health data must comply by standardizing electronic data interchange, and protecting confidentiality and security of health data. Additionally it has been made law that the individual in fact owns all health information available on him/herself. If an individual requests copies of personal health and medical information, the entity is legally required to provide it.

A number of Internet-based health sites offer health and medical record-keeping features for consumers. However, many people are leery of placing such private information on the Internet due to security concerns. There are also more usage barriers for Internet-dependent tools. Thus, there is a need in the art for a secure and ubiquitous electronic health and medical records repository.

Clearly, there exists a need for a method that would allow the individual to maintain his/her own health record. It would be desirable for the individual to be able to consolidate records from all his/her healthcare providers into one contiguous medical record so that the receiving provider could read the record as a single document. However, the combination of documents making up one's medical record may be confusing to the individual. It may also be quite bulky and its preservation and safe-keeping are essential. Hence, an electronic record coupled with software to organize data easily and appropriately would be desirable. Standardization of the format would make access much easier for the receiving practitioner as well. In addition, it may be desirable for the individual to be allowed to add self collected information into the medical record (e.g. periodic glucose measurements for a diabetic). Finally, the data must be organized such that the user can determine what emergency medical information he/she wishes to release to emergency medical personnel and which information he/she wishes to release only with his/her prior consent.

It would further be desirable for the user to be able to provide immediate access to his/her entire medical record whenever needed. In ideal circumstances an individual would be able to securely transport complete medical information to various providers at the individual's discretion, transcending all operating system barriers.

Flash memory devices have the advantage of being relatively inexpensive and requiring relatively little power as compared to traditional magnetic storage disks. However, in a typical flash memory device, it is not practical to rewrite a previously written area of the memory without a preceding page erase of the area. This limitation of most flash devices cause them to be incompatible with typical existing operating system programs, since data cannot be written to an area of memory within the flash device in which data has previously been written, unless the area is first erased.

Newer flash memory or flash devices are erasable and programmable non-volatile memory modules, known in the art for storage of information. Flash devices include electrically erasable and programmable read/write memories (EEPROMs) made of flash-type, floating-gate transistors and are non-volatile memories similar in functionality and performance to EPROM memories, with an additional functionality that allows an in-circuit, programmable, operation to erase pages of the memory.

Recently, a new USB (Universal Serial Bus) flash disk technology was disclosed in U.S. Pat. No. 6,148,354 by Ban, et al. The USB flash disk technology is compatible with all USB PC buses, available on 99.9% of computers built in the past 4 years worldwide. When coupled with appropriate encryption and/or password protection algorithms, this equates to a ubiquitous and secure method to send, receive, store, manage, transport and communicate health and medical information. The non-Internet dependent technology interface and security features provide an ideal fit with HIPAA. Additionally, the memory device can be carried at all times by the individual in the form of a small thumb-sized device, small card or key chain device.

The criteria of the USB standard are an ideal fit also: ease of access and PC (personal computer) expansion, low cost, rapid information transfer rates, and full support of real-time data (e.g. voice, audio, and compressed video).

A software management system is required to manage these functions of the flash memory device. To facilitate this management system and other functions advantageous to the management of the data some flash devices include a processor within the device. This processor may derive power from the interface when connected to a computer but requires no power when dormant.

### SUMMARY OF THE INVENTION

The present invention solves these and other problems by providing a system and method for an individual to control and transport his/her own medical record and other personal health and medical information on his/her person at all times using a secure memory device, hereinafter known as a Personal HealthKey, with a universally accepted interface. In the preferred embodiment the Personal HealthKey may be a USB flash memory device as described above. Furthermore, said Personal HealthKey may include an on-board processor so that data may be processed and communicated independent of what computer host it is connected with.

A first aspect of the present invention involves the storage of personal health records and/or other data on a non-volatile memory device which is easily portable by the user and which can be made secure. In the preferred embodiment this device is a flash memory device. Also in the preferred embodiment said flash memory device shall provide a USB or other widely accepted interface to allow the user, health care providers and others to easily access the information stored on the device. The USB flash memory device enables the secure storage, management, transport, and communication of health and medical information, including financial information, through connection to a USB defined bus. The USB flash memory device enables transport of health and medical information on a key chain or other easily portable device.

A second aspect of the invention involves a computer-implemented method for securely storing, managing, transporting, and communicating health and medical information on the flash memory device.

A third aspect of the invention involves the configuration of the flash memory device to auto launch emergency information (or other information as designated by the user). By auto launching emergency information, the user is able to provide said emergency data to a healthcare provider in the case where he/she has been incapacitated. He/she implicitly gives permission for access to this data by placing it in an unrestricted area of the memory. The provision of said emergency data allows the provider to access essential medical data immediately upon inserting the memory device into an appropriate interface device, such as a USB port of a personal computer. In order to auto launch this data, there must be appropriate application code stored on the memory device to access the emergency data and display it on the healthcare provider's PC.

A fourth aspect of the invention involves the data-encryption and/or password protection of user-directed health and medical information. The user may designate security levels of and store all facets of health and medical information including, but not limited to: user records, lab information, medical images, and financial data. The USB flash memory device will data-encrypt and password protect user-directed health and medical information, utilizing available security tools, such as: double access control, encryption using 3DES, DES (FIPS 46-3), scramble encryption/decryption performed on the fly and password hashing using SHA-1, security platform authentication unique identifier, Public Key Infrastructures, or digital signatures.

A fifth aspect of the invention involves the establishment of interfaces with information technology artifacts. The USB flash memory device will enable data interchange by interfacing with any information technology artifact to retrieve into its memory information including an individual's personal health record, electronic medical records, home monitoring device records, medical imaging data, lab data, pharmacy information, fitness equipment records, etc. Said information can be downloaded into the flash memory device using the USB or other commonly utilized port from such sources as a personal computer, the physician's computer, medical imaging instruments, laboratory instruments, pharmacy computers or web pages, fitness equipment, etc.

A sixth aspect of the invention involves the storage of all facets of health and medical information by USB flash memory device including, but not limited to: user records, lab information, medical images, fitness information, and financial data. This information will be stored and managed using a personal health record interface. The interface allows users to enter and update medical histories; keep current records on procedures, tests results, medical expenses, fitness information and insurance data; store medical images and reports in context; and communicate such information in full form or useful reports for transport using the USB flash memory device.

A seventh aspect of the invention involves storage, execution, viewing and management of health and wellness resources including, but not limited to: educational videos, community resources, health management guidelines and health forms. This information may be transported on a key chain or other easily portable USB flash memory device. Each item of information may be designated as to whether it requires a password for access and/or whether it is encrypted.

An eighth aspect of the invention involves the recording and storage of network or Internet links or URLs with appropriate passwords by USB Flash Memory or other storage device to allow downloading of additional records from other sources of records or information. Through this method the user may access information over the Internet or other network without using flash memory storage space. Typically, this option would be elected for information of a less confidential nature where the user is willing to assume the risks of downloading across a network.

A ninth aspect is to store program code, which can be used to interface, manipulate, display, and store data, including but not limited to personal health and medical information on the USB flash memory device or other storage device.

### BRIEF DESCRIPTION OF THE FIGURES

The various features of the present invention are illustrated in the figures listed below and described in the detailed description that follows:

FIG. 1 is a schematic diagram showing an embodiment of the present invention.

FIG. 2 is a schematic diagram showing a client, server, or client/server of the system of FIG. 1.

FIG. 3 is a schematic diagram of a user client accessing server web sites.

FIGS. 4A-4D are screen shots of a software application capable of being operated with the system of FIGS. 1-3, and utilizing the Personal HealthKey or other storage device in accordance with a preferred embodiment of the present invention.

FIGS. 5A-5G are screen shots showing general information screens of a software application shown in FIG. 4A-4D.

FIGS. 6A-6D are screen shots showing Visit Screens of the software application shown in FIGS. 4A-4D.

FIGS. 7A-7K are screen shots showing the Medical Details screens of the software application shown in FIGS. 4A-4D.

FIGS. 8A-8B are screen shots showing the Complete History screen of the software application shown in FIGS. 4A-4D

FIG. 9A is a screen shot showing the Communications screen of the software application shown in FIGS. 4A-4D

FIGS. 10A-10B are screen shots showing the Web Maintenance screen and Personal Health Page of the software application shown in FIGS. 4A-4D.

FIGS. 11A-11I are screen shots showing the financial information stored on the Personal HealthKey or other storage device.

FIG. 12A shows the Emergency Medical Card.

FIG. 13A is a bottom view of a combined credit card and CD ROM capable of storing the software application of the present invention.

FIG. 13B is a top view of combined credit card and CD ROM shown in FIG. 13A.

FIG. 14 shows a Block Diagram of the Personal HealthKey

FIG. 15 shows a basic memory allocation diagram of the Personal HealthKey.

FIG. 16A-16F shows the integration of the Personal HealthKey software and hardware.

### DETAILED DESCRIPTION OF THE INVENTION

The invention comprises a computer-implemented, fully transportable method for securely storing, managing and retrieving health and medical information in such as medical records, personal health records, reports and medical images including:

(i) Inputting, storing, managing, and communicating health and medical information such as:

a. family medical history,

b. personal medical history

c. medical emergency contacts,

d. medical contacts,

e. billing organization information,

f. insurance information,

g. medical reminders,

h. office visit and hospitalization information,

i. history of conditions and problems,

j. vital signs and laboratory information,

k. fitness and exercise tracking

l. alternative treatments

m. test and treatment results,

n. images of clinical data including X-rays, MRIs, EKG's and video images to name but a few,

o. medications,

p. immunizations,

q. records of patient communications with care providers,

r. medical expenses,

s. health care financial information including but not limited to billing organizations, medical savings accounts, etc., and

(ii) Inputting health and medical information from selected sources including but not limited to:

a. HL7 interface

b. individual

c. home monitoring device

d. fitness center

e. dietary monitoring devices

f. pharmaceutical databases,

g. clinical research organization

h. medical professional

i. hospital or health system

j. disease management organization

k. imaging organization or system

l. insurer or payor

m. pharmacies; and

n.

(iii) Storing and communicating medical emergency information; and

(iv) Securely storing the health and medical information including medical records, personal health records, medical images and reports; and

(v) Transporting the health and medical information including medical records, personal health records, medical images and reports; and

(vi) Retrieving the health and medical information including medical records personal health records, medical images and reports.

Health and medical information and records may be derived from a number of sources including, but not limited to, the following:

Medical Records from;

a. Individual's healthcare providers, which may include

i. Individual's history of conditions and problems

ii. Medical reminders

iii. Individual's vital signs and laboratory remits

iv. Individual's family medical history

v. Individual's test and treatment results

vi. Individual's immunizations records

vii. Records of individual's communications with physicians

viii. Individual's medication records

ix. Individual's preventive and miscellaneous orders

b. Individual's fitness center

c. Pharmaceutical databases (e.g. user medication records)

d. User's office visit and hospitalization information

e.

f. EMR records

Electronically Collected Results and Data from;

a. Images of clinical data including X-rays, MRIs, EKG's and video images (Note, these could be directly collected or scanned images)

b. Any electronic instrument with a suitable interface, e.g. an HL7 interface

c. Home monitoring devices (e.g. cardiac monitors, glucose monitors etc.)

d. Dietary monitoring devices

Information Directly Input to a Personal Health Record by the Individual which may include;

a. Individual's observations and notes

b. Individual's family medical history

c. Individual's medical emergency contacts

d. Individual's medical contacts

e. Individual's billing organization information

f. Individual's insurance information

g. Medical reminders

h. Records of the individual's communications with physicians

i. Individual's medicines

j. Individual's medical expenses

k. Individual's fitness routines

Healthcare Financial Information including, but not limited to:

a. Billing organizations

b. Medical savings accounts, etc.

c. Individual's insurance information

d. Individual's medical expenses

e. Medical payments

f. Deductible status

Information For a Medical Emergency Card

The system includes a portable memory device (Personal HealthKey) 218 configured to store instructions and, in some configurations, a processor configured to execute instructions for inputting, securely storing, managing and retrieving the medical records.

In the preferred embodiment of the present invention, the Personal HealthKey memory device 218 is a USB flash memory device configured to operate with CapMed's Personal Health Record (PHR) software. In this section reference will be made to the functions of the PHR to demonstrate the operation and use of the Personal HealthKey memory device 218. It should be recognized that the invention may be configured to operate with other software systems and that such re-configurations are within the intent of this invention.

The HealthKey 218 can serve as a complete mechanism for storing the entire PHR and all medical information including images. Emergency information will auto launch from the HealthKey 218 when plugged into the USB port of any computer. The entire medical record resides data-encrypted behind a password. Thus, the Personal HealthKey 218 integrates Personal Health Record (PHR) with USB Flash-disk technology.

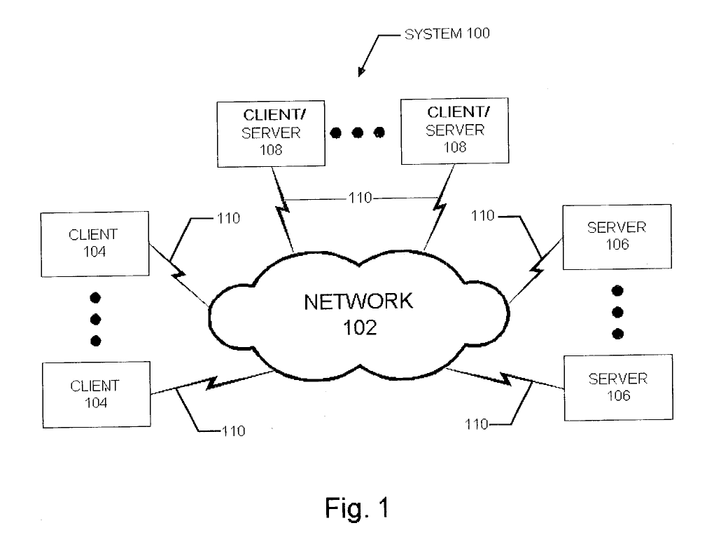

FIG. 1 depicts the communications networks of the prior art wherein the system 100 includes a network 102 that interconnects client entities, 104, server entities, 106, and client/server entities, 108, via communication links 110. Network 102 may comprise an Internet, intranet, extranet, local area network (LAN), wide area network (WAN), metropolitan area network (MAN), telephone network such as the public switched telephone network (PSTN), or a similar network. Use of such networks exposes confidential data to the risk of interception.

A client or server entity may include software (such as programs, threads, processes, information databases, or objects); hardware (such as a computer, a laptop, a personal digital assistant (PDA), wired or wireless telephone, or a similar wireless device); or a combination of both software and hardware. A client entity 104 is an entity that sends a request to a server entity and waits for response. A server entity 106 is an entity that responds to the request from the client entity. A client/server entity 108 is an entity where the client and server entities reside in the same piece of hardware or software. Connections, 110, may be wired, wireless, optical or a similar connection mechanisms.

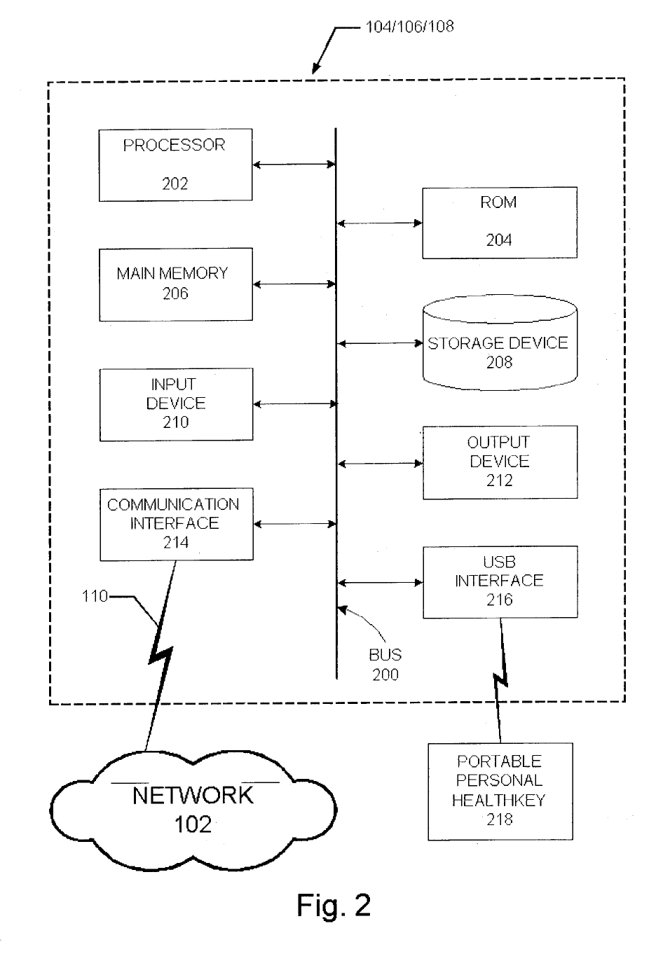

FIG. 2 shows a client or server entity 104, 106 or 108 used in the system of the present invention, or to perform the method steps of the present invention. The entity includes a bus 200 interconnecting a processor 202, a read-only memory (ROM) 204, a main memory 206, a storage device 208, an input device 210, an output device 212, a communication interface 214, a USB (or other standard) interface 216 and a Personal HealthKey flash memory device 218. ROM 204 includes a static memory that stores instructions and data used by processor 202. The Personal HealthKey 218 may also store instructions and data used by processor 202.

The USB interface 216 provides a standardized interface for the Personal HealthKey flash memory device 218. Through this interface the Personal HealthKey 218 is able to upload and download data and program instructions to/from the client/server host entity. Programs stored on the Personal HealthKey 218 can be executed by the processor 202 either in an auto-launch mode or by selection. When the Personal HealthKey 218 is connected to the USB interface port 216, it functions much like a conventional disk drive with automatic play capability similar to a conventional CD ROM.

Main memory 206, which may be a RAM or another type of dynamic memory, makes up the primary storage of entities 104/106/108. Secondary storage of entity 104/106/108 may comprise storage device 208 (such as hard disks, tapes, diskettes, Zip drives, RAID systems, holographic storage, optical storage, CD-ROMs, magnetic tapes), USB flash memory device 218, and other external devices and their corresponding drives. Input device 210 may include a keyboard, mouse, pointing device, sound device (e.g. a microphone, etc.), biometric device, or any other device providing input to entity 104/106/108. Output device 212 may comprise a display, a printer, a sound device or other device providing output. Communication interface 214 may include network connections, modems, or other devices used for communications with other computer systems or devices.

As will be described below, a client entity 104 consistent with the present invention may permit a user to securely store and retrieve electronic medical records or other personal health information, and manage medical expenses. Entity 104 performs this task in response to processor 202 executing sequences of instructions contained in a computer-readable medium (the PHR software application), such as main memory 206 or Personal HealthKey 218.

Execution of the sequences of instructions contained in main memory 206 or Personal HealthKey 218 causes processor 202 to perform processes that will be described later. The present invention is not limited to any specific combination of hardware circuitry and software.

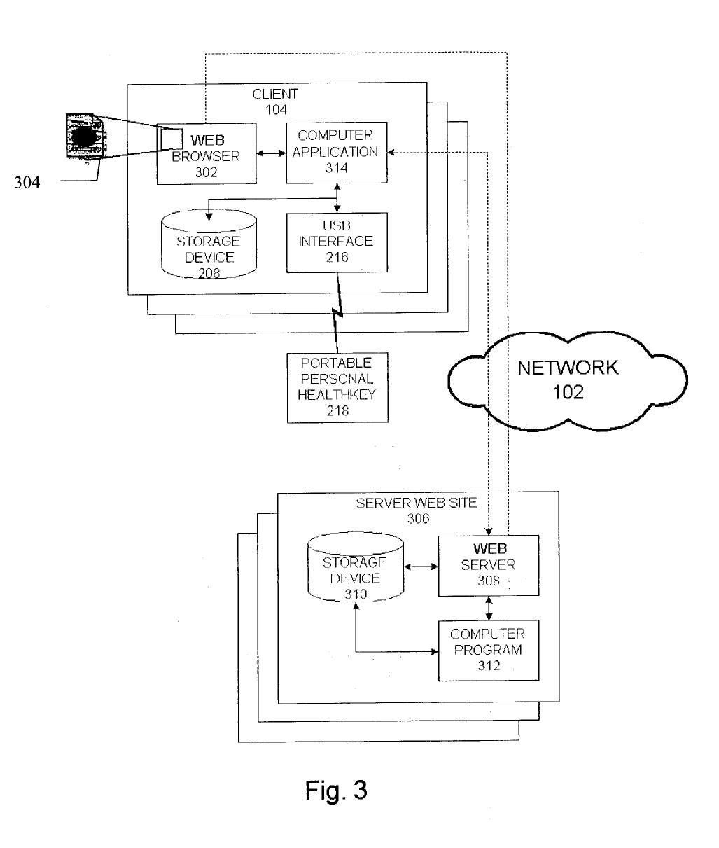

The majority of features of the PHR software application are performed internal to a client entity 104, as shown in FIG. 2. Such an arrangement ensures that medical records, personal health information, and expenses are securely stored and retrieved by a user. However, as shown in FIG. 3, client entity 104, which runs the software application, is capable of interfacing with server-based web sites 306, via network 102. The software application is stored in storage device 208 or on the Personal HealthKey 218 of user client entity 104, and is executable therein. However, if a user wishes to access server-based web sites 306, the software application 314 connects thereto via a web browser 302 (executed on user client entity 104) and network 102. Information received from server-based web sites 306 is displayed on a web page 304 of web browser 302. Addresses for the web sites 306 may be stored on the Personal HealthKey 218 or on the client storage device 208 and accessed by browser 302 via the USB interface 216.

Server-based web site 306 includes a web server 308 connected to a storage device 310 and a computer program 312. Computer program 312 is operative to extract data from storage device 310. Storage device 310 includes HTML documents and data, depending on what type of web site is being accessed by the software application. Web server 308 and computer program 312 interact with the information stored on storage device 310 in a conventional manner, and provide the information to web browser 302 or computer program 314 of user client entity 104. The information from server-based web site 306 is displayed on web page 304 of web browser 302 in a conventional manner or is stored on storage device 208 and 218 of client 104.

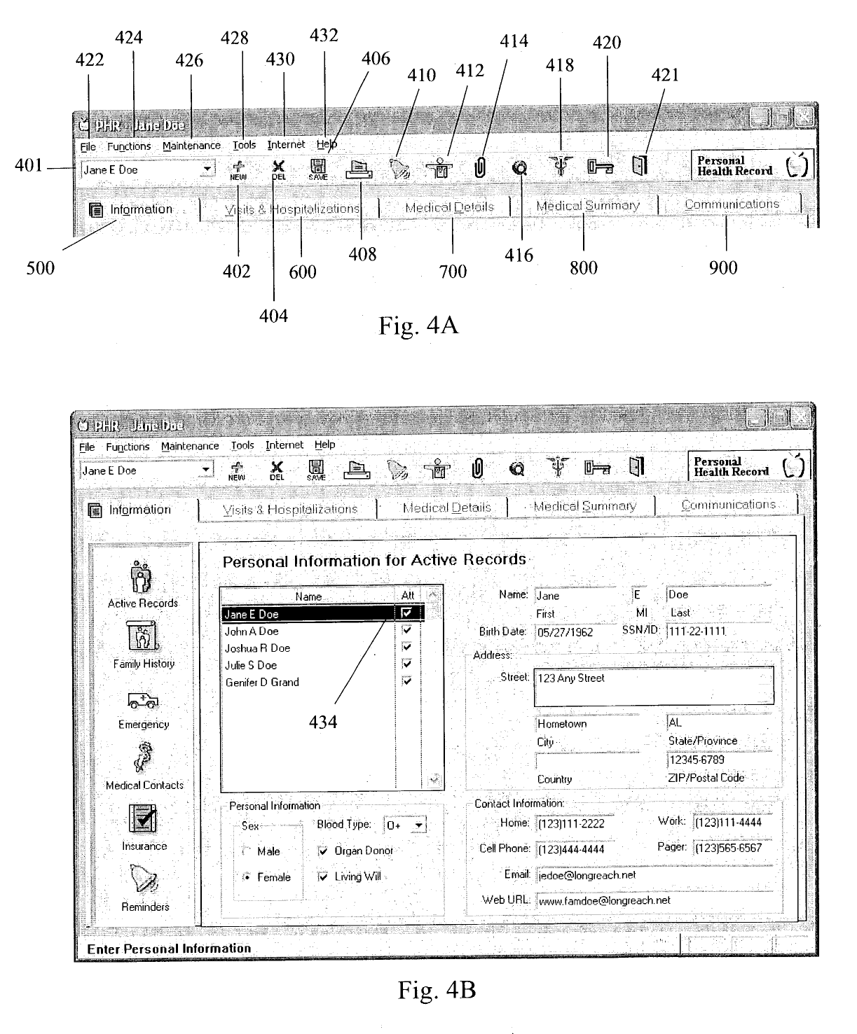

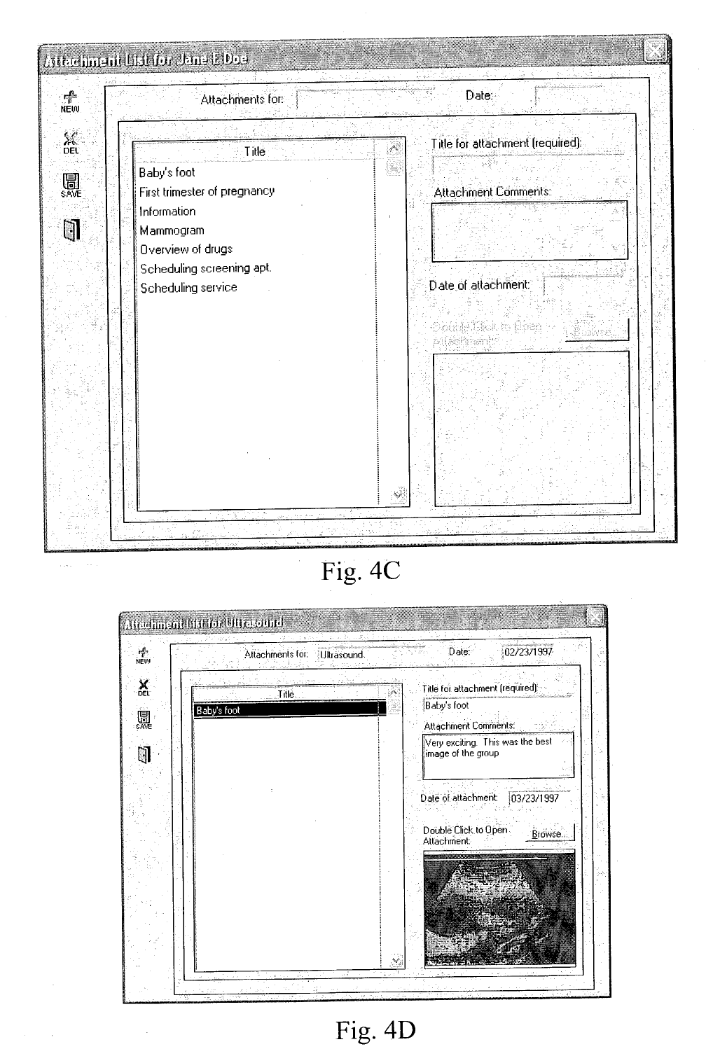

In a preferred embodiment, the PHR system includes a graphical user interface to access system functions as shown in FIGS. 4A and 4B. Shown in FIG. 4A is a graphical user interface window which enables a user to access all of the features of the present invention. A series of icons and pull-down menus are displayed in FIG. 4A. A user may select themselves from a pull-down menu 401, or select a family member from this same menu 401. Menu 401 may be accessed while any of the screens of the application are displayed.

By highlighting a screen button and clicking on the NEW icon 402, a user is capable of adding a new data item to the category of data that the screen button organizes: an active record for a new family member, administrative detail, family history observation, condition, medication, test, treatment, immunization, visit, communication, etc. To add a new medicine, for example, the user clicks open the Medical Details tab, clicks the Medications screen button and then selects the desired medication from a pick list that is presented.

The DEL icon 404 allows a user to delete a highlighted item from a list or text field. The SAVE icon 406 allows a user to save the current information input by the user into a database stored in storage device 208 or in the Personal HealthKey 218. Icon 408 allows a user to print reports or email chart information, including automatically assembled and organized reports and the information from all tab screens. The reports may include, for example, his/her entire medical history; general information (such as address, phone number and birth date); family history; medical contacts (including doctors and other healthcare providers); emergency contacts; insurance policy information; reminders; all or current conditions; all activities related to a specific problem or condition; all or current interventions (such as medications, tests, treatments, and immunizations); a list of all visits for a family member; details for each visit (including medical communications-telephone, letter, email exchanges); vitals and profiles and associated graphs, emergency information, and the contents of PHR pick lists.

Icon 410 allows a user to set alarms, as described more fully below. Icon 412 allows a user to display the condition for which an intervention was performed or visit conducted. Icon 414 allows a user to attach digital images and other electronically formatted data to the entries to which they pertain, including still and motion video images, web pages, and imaged documents and reports, as described more fully below. Icon 416 allows a user to access the Internet and view a customized Personal Health Page, as described more fully below. Icon 418 enables a user to access the Emergency Card wizard, icon 420 allows a user to view and send information to the Personal HealthKey, and icon 421 allows a user to exit the PHR software program.

As is common with most Windows-based applications, FIG. 4A includes a plurality of pull-down menus. A File pull-down menu 422 enables a user to configure the tool and status bars; open, backup, change, and restore a database; print chosen sections of the chart; and exit the program. A Functions pull-down menu 424 enables a user to add, delete and save highlighted items and display reminders, conditions, and attachments that are associated with highlighted items. These duplicate the functions of the icons on the tool bar described above. A Maintenance pull-down menu 426 enables a user to edit (add to, delete from, otherwise edit, and save) items on the Background Lists, including lists of immunizations, medications, preventive/miscellaneous items, problems (allergies/adverse reactions, conditions, diagnostic disorders, risk factors, symptoms), tests, treatments; to modify Profiles (edit, delete, copy, print, save) and to build new ones with the Profile Builder; to set up and modify communications and treatment Location preferences; to manage the Medical Specialist List (edit, delete, copy, print, save); and to manage personal favorite web links. A Tools pull-down menu 428 enables a user to provide for setting a database password, setting the time preference for reminder alerts, selecting regional preferences (Date Format, Social Security Number, Zip Code Format, Phone Number Format); setting server update frequency option; and checking for new updates. An Internet pull-down menu 430 enables a user to open a web browser within the chart. Finally, a Help pull-down menu 432 enables a user to open conventional Windows help files, identifies the version number of the software and its creators, and provides e-mail access for technical and corporate support.

As further shown in FIG. 4A, a number of tabs are displayed, which enable a user to enter and access a variety of medical information to/from the Personal HealthKey memory 218 using the PHR software application. The tabs include:

1. An Information tab 500,

2. A Visits & Hospitalizations tab 600,

3. A Medical Details tab 700,

4. A Medical Summary tab 800, and

5. A Communications tab 900.

The PHR software application permits attachment of digitized images, reports and other files to a user's medical records and personal health information, as shown in FIGS. 4B and 4C. Users can attach digitized images and imaged documents to visits, medical conditions, tests, treatments, immunizations, and medications via the “Att” box 434, as shown in FIGS. 4B, 5A, 5B, 5C, 5D, 5E, 5F, 6A, 7A, 7G, 7H, 71, 7J, 7K, 8A, 11A, 11B, 11H, 11I, and 16A. Information downloaded from the World Wide Web can also be attached as users research and gather information about their personal conditions. When an attachment to an item is added, a checkmark appears in the “Att” box 434 beside that item. This capability provides a contextual library function pertinent to users' conditions. This information may be stored on the Personal HealthKey 218 or other memory device 208. If an attachment (e.g., an image of an x-ray) exists, then clicking the “Att” checkbox will display that picture (FIG. 4D).

Information Tab

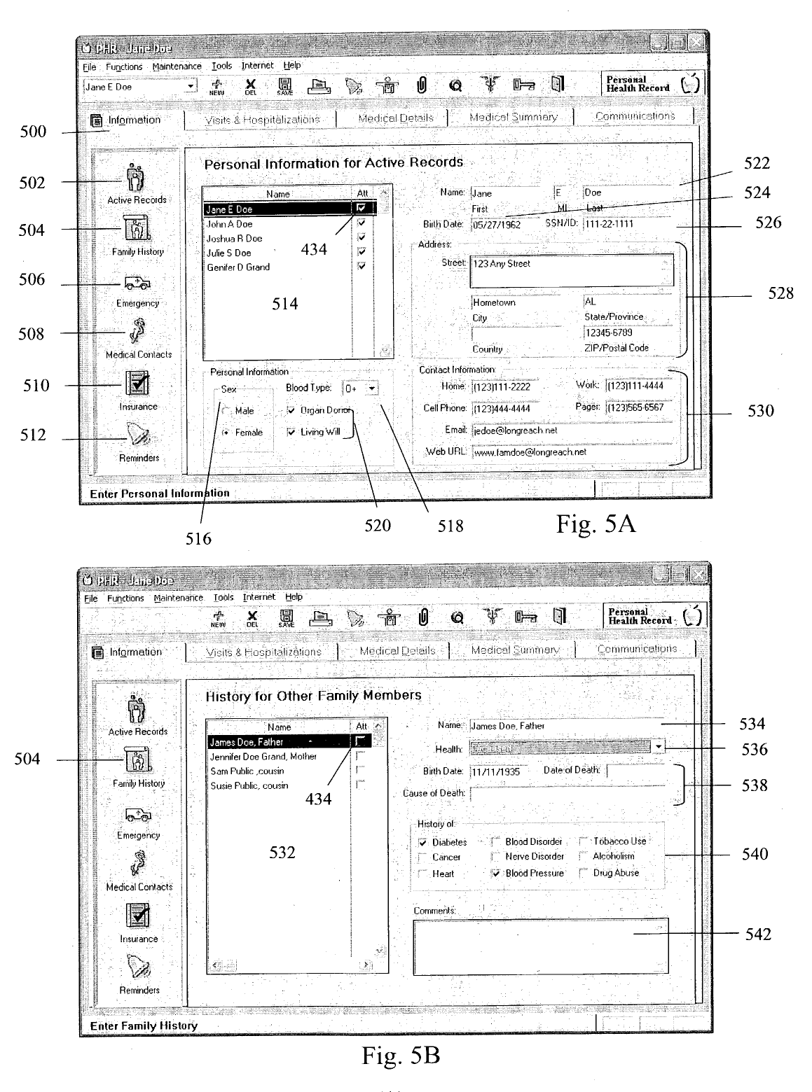

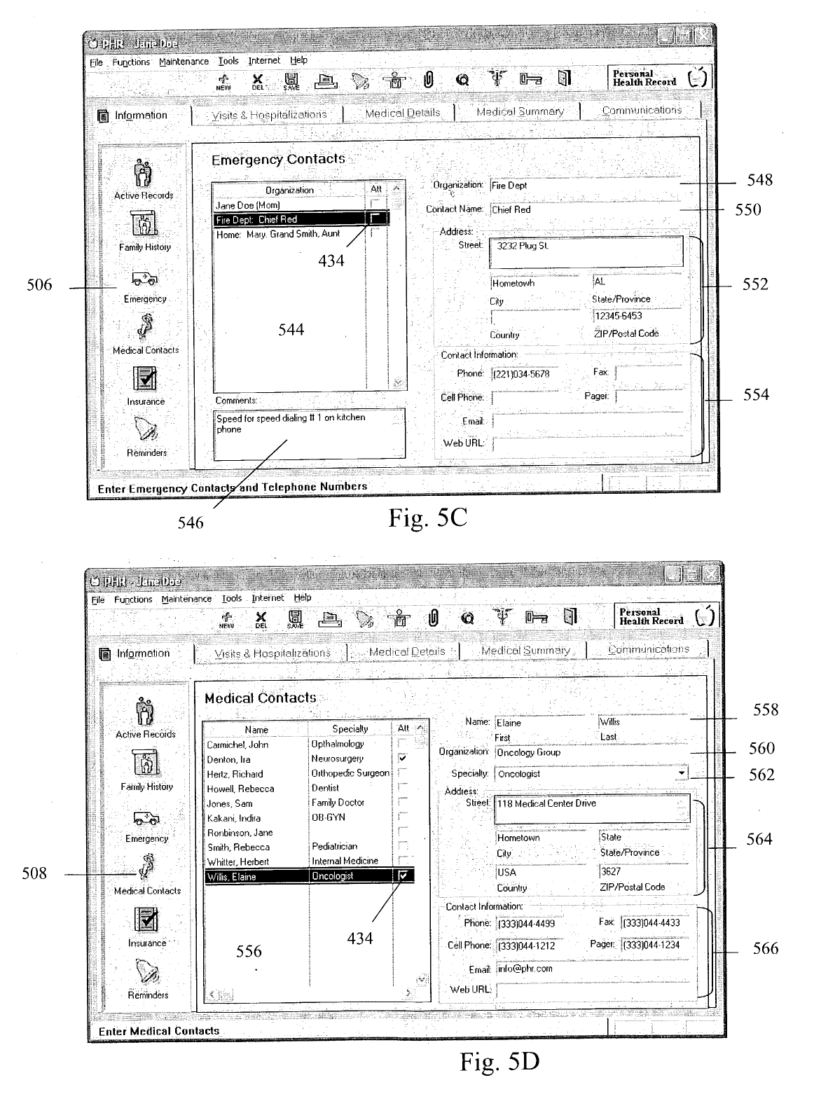

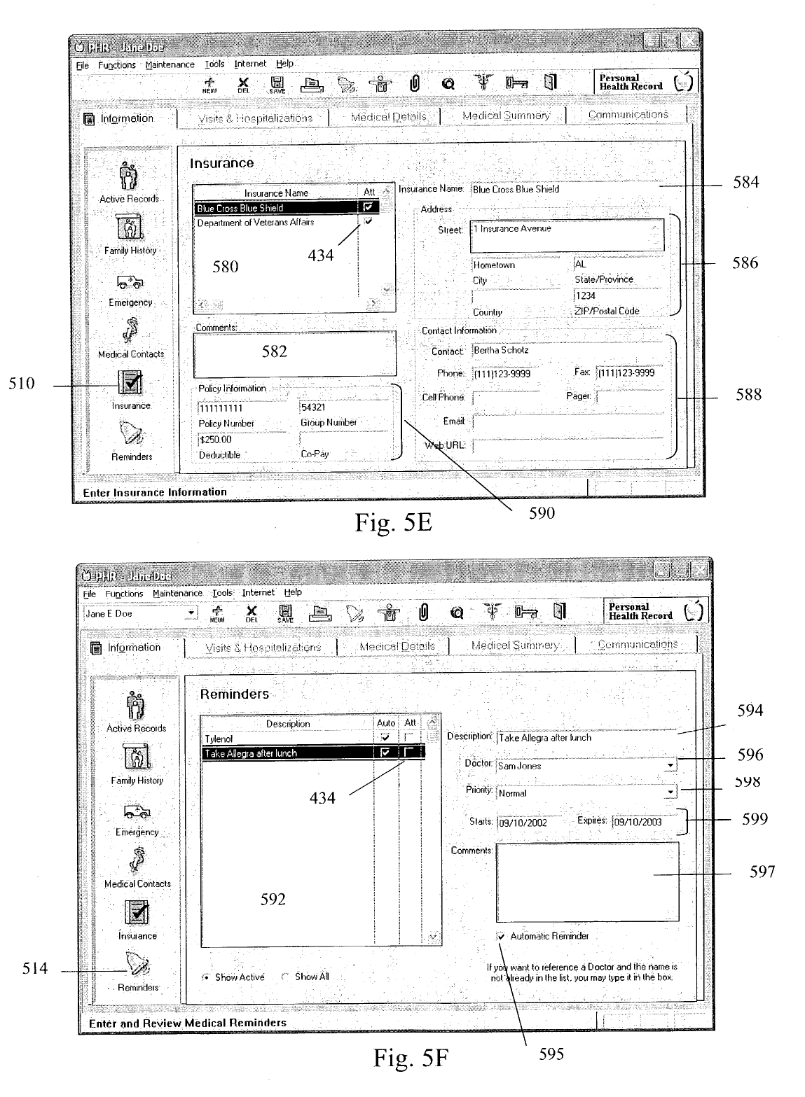

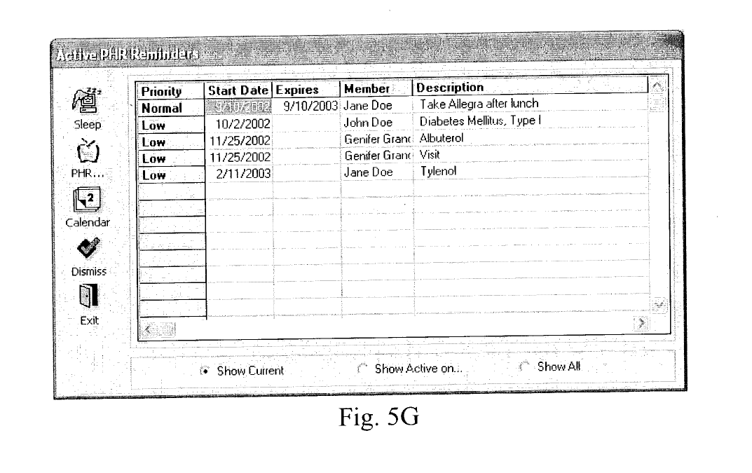

With the Information tab 500, FIG. 5A, a user can enter a variety of personal information to help maintain complete and accurate records for his or her family. A user may add and review the following types of general information by clicking on the appropriate icon with the input device 210:

Names Of Individuals whose information is in the system can be selected by clicking on an Active Records icon 502 (FIG. 5A) the names of the individuals are listed in table 514;

A user may input information such as the member's name 522; Sex 516; Blood Type 518; whether the family member is an organ donor or has a living will 520; birth date 524, social security number 526, address 528, and contact information 530. Attachments such as birth certificates can be tied directly to a family member's name with the “Att” 434.

Family History by clicking on a Family History icon 504;

At the doctor's office, users are usually asked to provide family medical history to assist physicians in their care. Often, individuals do not have the required history readily available. Using the Family History screen as shown in FIG. 5B, a user can enter their family's relevant medical history for easy access and retrieval in report format. A user may input information such as the family member's name 534, the health status (excellent, good, fair, deceased) 536, date of birth and death related information if applicable 538, health history of standard disorders 540, and a field to enter comments 542. The family members are listed in table 532. Attachments such as birth or death certificates can be tied directly to a family member's name with “Att” 434.

Emergency Contacts by clicking on an Emergency icon 506;

In emergencies, it is critical for caregivers to have the names of the appropriate people to contact. A user may input the names, addresses, phone, and fax numbers of emergency contacts, along with detailed comments, as shown in FIG. 5C, and may select an emergency contact by choosing from the list displayed in window 544. A user may input information such as comments 546, organization 548, contact name 550, address 552, contact information 554. Attachments relative to the emergency contacts can be tied directly to the field with “Att” 434.

Medical Contacts by clicking on a Medical Contacts icon 508;

As shown in FIG. 5D, a Medical Contacts icon 508 displays the Medical Contacts screen which provides a list of all of the family's physicians or other care providers. In addition, names in this list provide information for lists on medical screens where a provider's name is required. A user may select a medical contact by choosing the contact from the list displayed in window 556. The user may input a name of the contact 558, an organization 560, a specialty 562, an address 554, and contact information 566. Attachments relative to the medical contacts can be tied directly to the field with “Att” 434.

Insurance Information by clicking on Insurance icon 512;

Rather than locating forms or insurance cards for insurance information, a user may enter relevant insurance information, and print it out for the physician or for his/her own records. The Insurance screen, FIG. 5E, also includes specific information about the details of an insurance plan and about which PHR members are covered under the plan. Insurers are listed in table 580. The user may input comments 582, insurance company name 584, an address 586, and contact information 588. A user may also input policy information by entering the appropriate information in the fields of section 590 (e.g., policy number, group number, deductible date, co-pay). Attachments relative to the insurance information in table 580 can be tied directly to the field with “Att” 434.

Reminders by clicking on the Reminders icon 514;

As shown in FIG. 5F, PHR provides reminders to help a user remember appointments, medications, or any other health-related events or issues. Reminders can be set throughout PHR by highlighting any field in a display table and clicking the Reminder icon 514 and adding the desired text (e.g., a medication on the medications list or a doctor on the Visits & Hospitals list). Reminders can also be set and reviewed directly by clicking on Reminders icon 514. A user may display the details of a reminder by choosing (highlighting) the reminder name from the list displayed in window 592. For each reminder, the user may input a description 594, select a doctor from pull-down menu 596, select a priority from a pull-down menu 598 (e.g., Normal, High, Low), enter start and expiration dates 599, and add comments in field 597. By checking box 595 a user can set a reminder to display automatically, FIG. 5G, when the computer is turned on or when the Personal HealthKey is inserted or at intervals during the day. Reminders can also be customized and pre-programmed. Attachments relative to the reminder information in table 592 can be tied directly to the field with “Att” 434.

Visits & Hospitalizations Tab

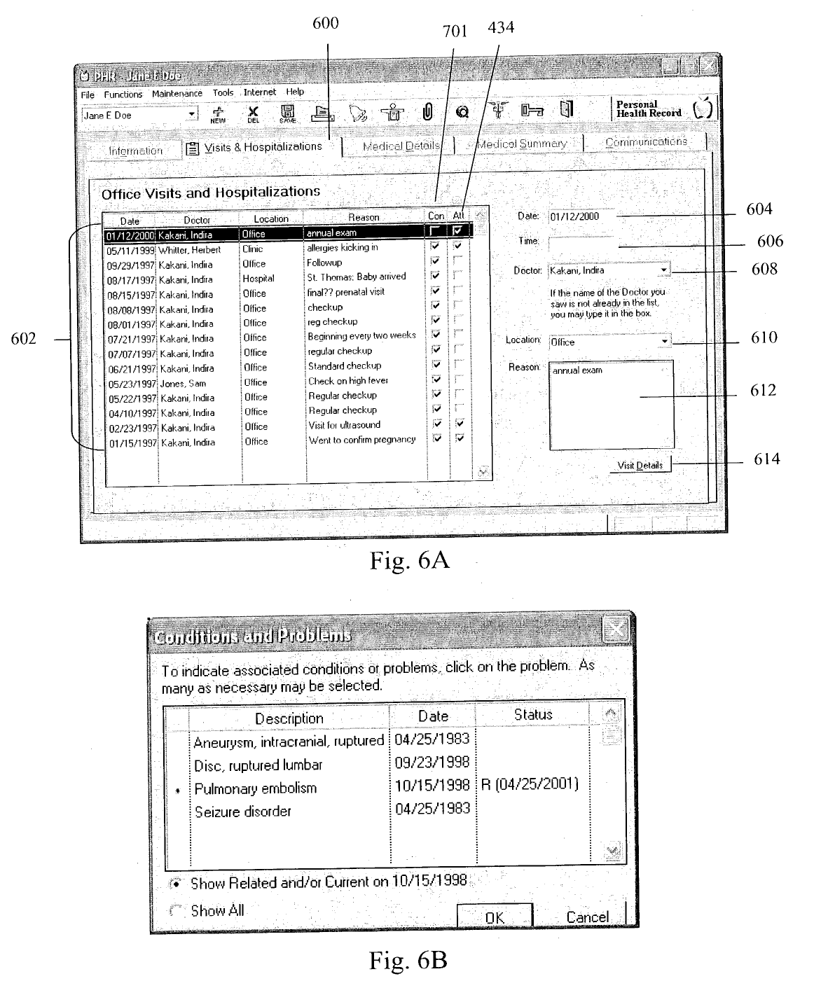

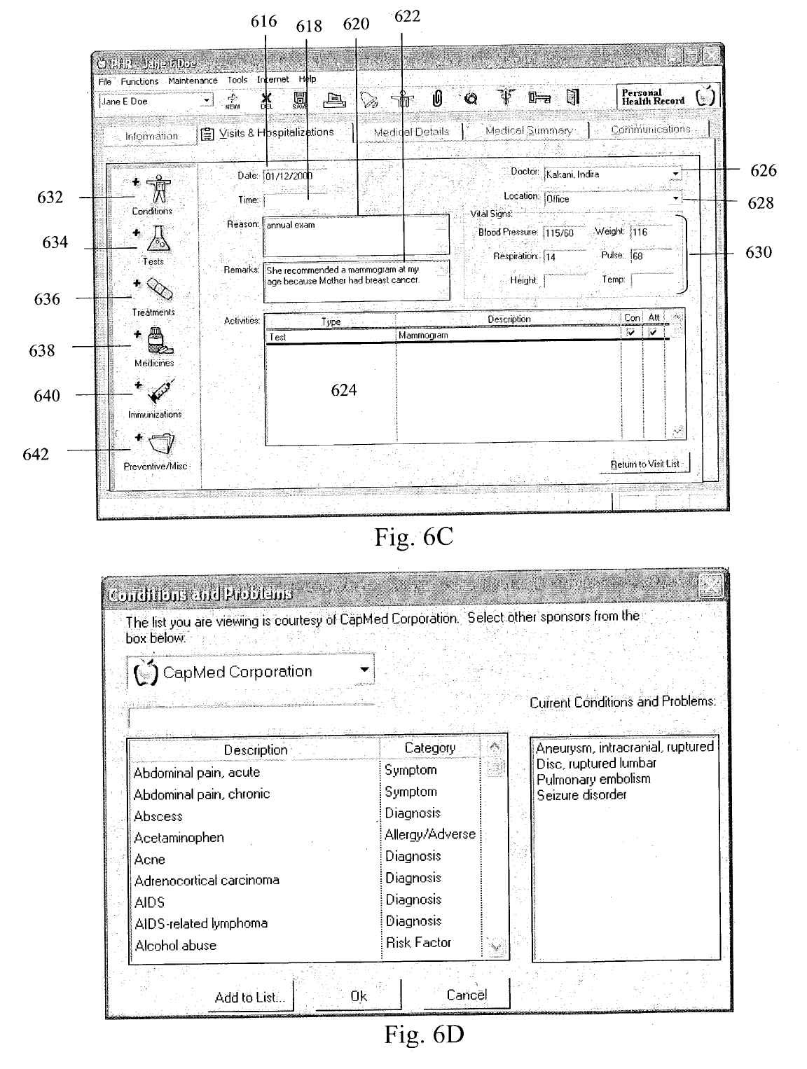

The PHR software application enables a user to record all doctor's visits and hospitalizations on the Personal HealthKey 218 or other memory device 208 by selecting the Visits & Hospitalizations tab 600. This tab contains two screens: an Office Visits and Hospitalizations screen as shown in FIG. 6A, and a Visit Details screen as shown in FIG. 6B.

The Office Visits and Hospitalizations screen shown in FIG. 6A contains a table 602 listing all visits and hospital stays for the designated family. Columns labeled “Con” 701 and “Att” 434 are found in the display tables indicating “condition” and “attachment”, respectively. The checkboxes under each column automatically fill as certain data is entered in the course of completing the chart. If “Con” is double-clicked, the medical condition pertinent to the highlighted item is displayed, (e.g., a “Con” checkbox on the visit of Aug. 27, 1998 in the example might open a window that identifies the condition(s) treated at that visit).

As demonstrated in FIG. 6B, conditions will appear in a window adjacent to the screens from which the user selects medical interventions (e.g., tests, treatments, medications, preventative/miscellaneous items). When an item is selected from an intervention screen, it can be associated with a related condition. Once the intervention is associated with a condition and/or problem, the “Con” check box next to the intervention is automatically checked. This ensures that interventions are associated with the correct condition and/or problem. The interventions and associated conditions and problems are stored in the Personal HealthKey 218 or other memory device 208.

All condition and attached data may be stored on the Personal HealthKey 218 or other memory device 208. The Office Visits and Hospitalizations screen (FIG. 6A) can be used for inputting and reviewing the date 604, time 606, doctor 608, location of 610, and reason for 612 a visit selected from table 602. A user may switch to the Visit Details screen by selecting a Visit Details button 614.

A user may use the Visit Details screen shown in FIG. 6C to record the same information recorded on the Medical Details tab 700 (described below), but this information is associated with a particular doctor visit. If a user is entering medical information resulting from a specific doctor's visit, the Visits & Hospitalizations tab 600 should be used to provide the most complete records of a family's health. Items entered on the Visit Details screen are automatically transferred to the appropriate table (Conditions, Tests, etc.) on the Medical Details tab 700. A user may enter the following information in the Visit Details screen: date of the doctor's visit 616, time of visit 618, reason for the visit 620, remarks 622, activities 624 (e.g., prescribed medication, problem treated, etc.), doctor visited 626, location of visit 628, and vital signs recorded during visit 630 (e.g., blood pressure, respiration, height, weight, temperature, etc.). A user may edit previously entered information, or add a new visit to the list. The user can enter conditions 632, tests 634, treatments 636, medications 638, immunizations 640 and preventive/miscellaneous information 642 from available pick lists of data related to a visit, as shown in FIG. 6D.

Medical Details Tab

Using Medical Details tab 700, a user may input a wide variety of medical information, independent of a specific visit or hospitalization. A user can store the following types of medical information using the Medical Details tab 700:

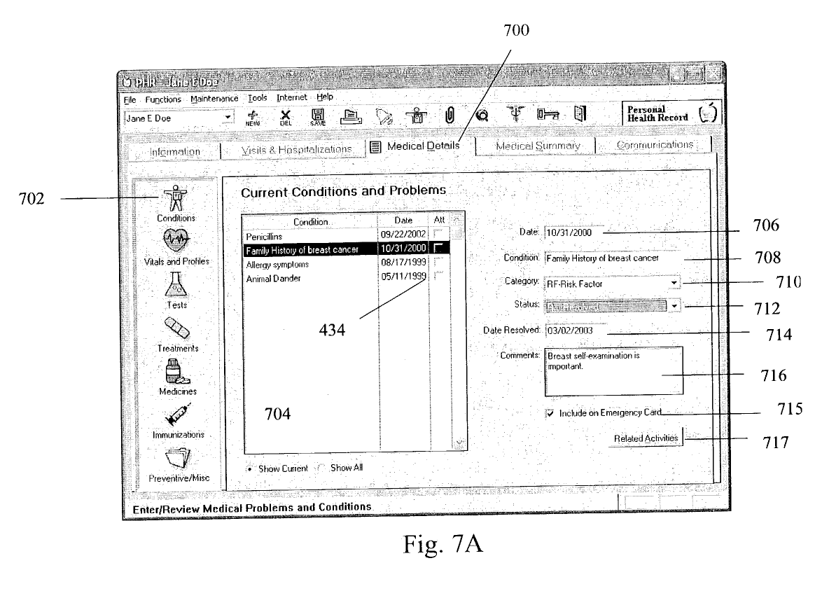

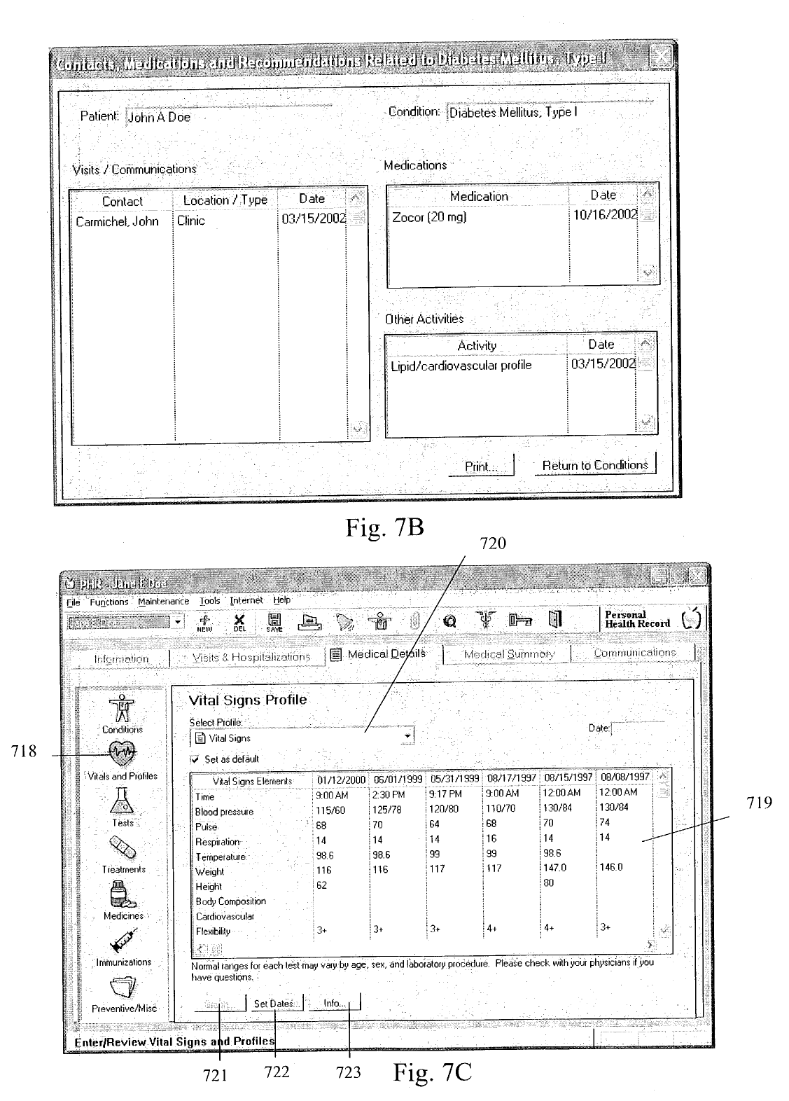

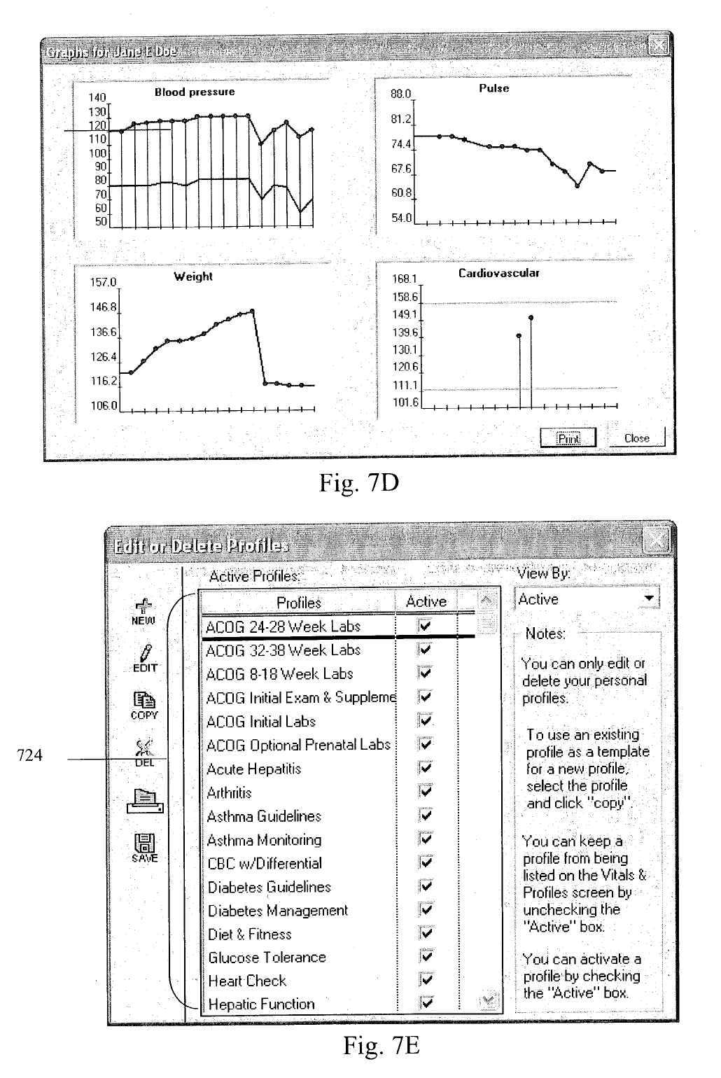

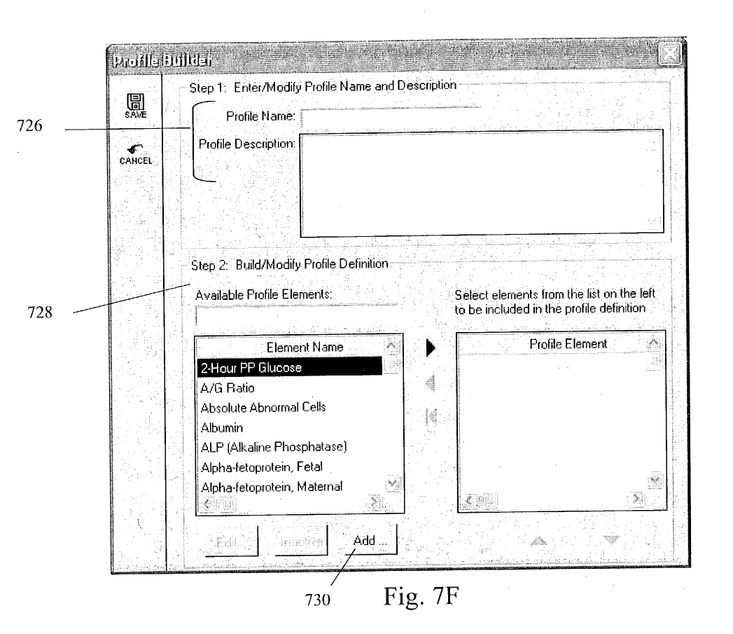

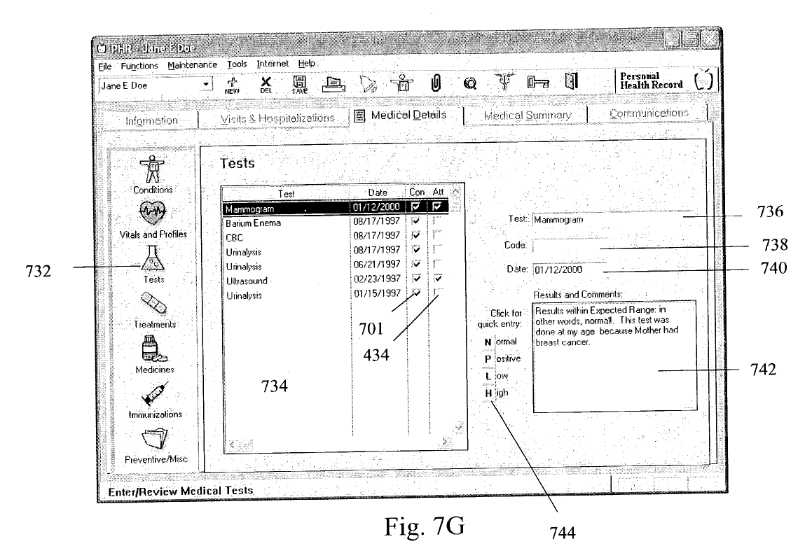

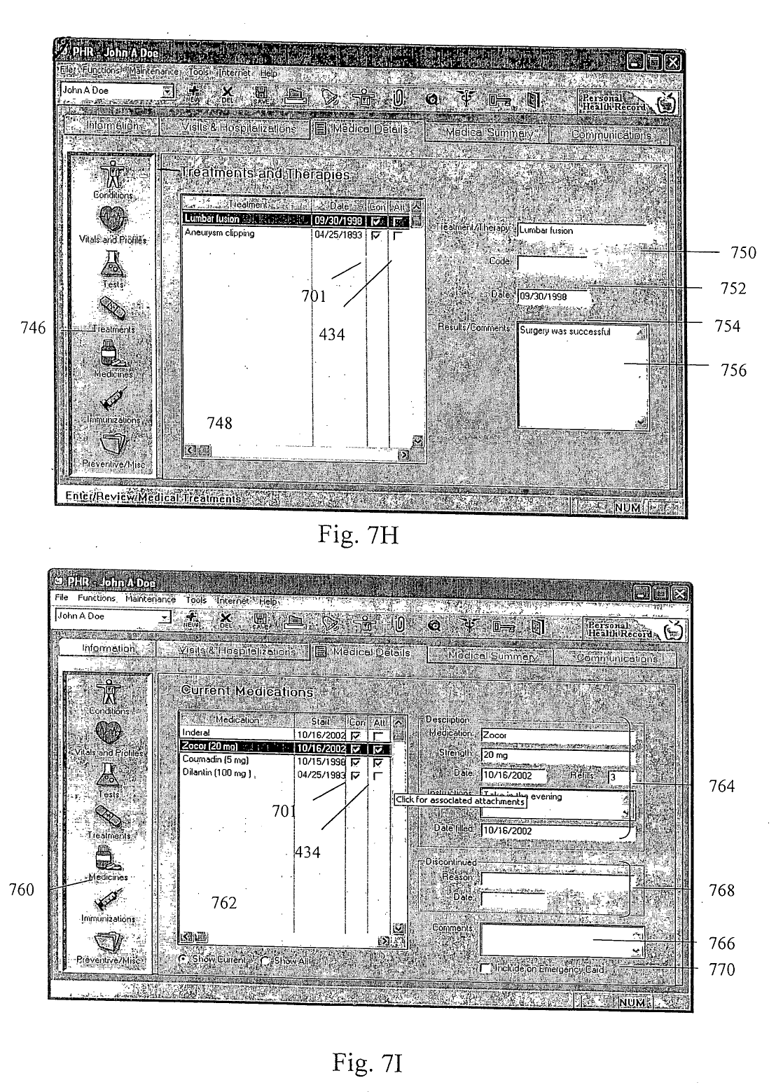

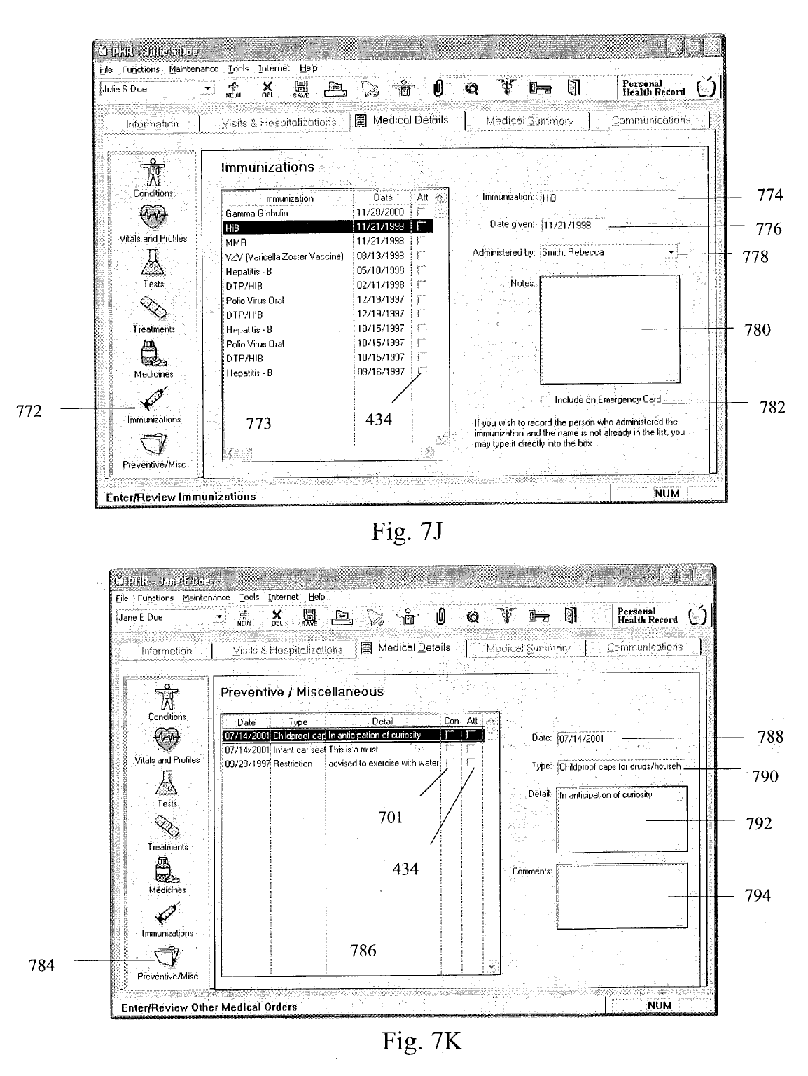

Conditions And Problems (FIGS. 7A and 7B);

The Complete History of Conditions and Problems screen may be displayed by clicking on a Conditions icon 702. Most doctors use a “problem-oriented” approach to user care. Problems can range from a diagnostic disorder, such as a stomach ulcer, to unexplained complaints, such as a headache of unknown cause, unexplained lab results, allergies, and risk factors. A user may review and edit a condition by choosing the condition name from the list displayed in window 704. A user may also input a date 706 and a condition name 708. The user may select a condition category (e.g., allergy, diagnostic disorder, risk factor, symptom, unexplained) from pull-down menu 710, the status of condition from a pull-down menu 712 (e.g., active, resolved, chronic, etc.), and input the date the condition was resolved 714 as well as comments 716. The user can view activities related to a particular problem or condition by selecting the Related Activities button 717 (FIG. 7B). The user can choose to send selected information directly to the emergency card by selecting the checkbox labeled Include on Emergency Report 715.

Vital Signs and other medical information to be tracked over time (FIGS. 7C and 7D);

The Vital Signs Profile screen shown in FIG. 7C may be displayed by clicking on the Vitals and Profiles icon 718. The Vitals and Profiles screen allows a user to record medical details or fitness profiles that they want to track over a period of time 719, such as blood pressure, weight, white blood cell count, red blood cell count, glucose, and cholesterol levels and other laboratory chemistry panels. Vital signs, chemistry profiles, and other data whose value is increased by sequential display of results are often recorded in such flow sheets from which they can be graphed. A user may select a desired profile for review and edit by choosing the profile name from the list displayed in drop-down menu 720. A user may repeatedly add new results from subsequent tests (or observations) to a chosen profile. A series of results can be graphed by selecting Graph 721, identifying the elements from the Select Items to be Graphed dialog box and clicking OK, as shown in FIG. 7D. A date range may be set with the Set Date 722 button and information related to the data elements can be obtained from the Info button 723.

The Profile Builder of the PHR software application allows a user to build personal profiles for tracking related medical information, as shown in FIGS. 7E and 7F. The software provides a set of standard profiles 724, permits users to define their own custom profiles 726 by picking from a list of profile elements 728, and allows users to add their own profile elements 730 to the existing list. As used herein, the term “profile” means a list of related items that can be tracked over a period of time, and the term “profile element” means a single item within a profile.

Tests And Test Results (FIG. 7G);

The Tests screen shown in FIG. 7G may be displayed by clicking on the Tests icon 732. The Tests screen allows a user to enter and review detailed information about medical tests and their results. A user may select a desired test for review and edit it by choosing the test name from the list displayed in table 734. For each test, a user may input a test name 736, a test code 738 (e.g., a current procedural terminology or CPT code), a test date 740, and comments 742. The user may also select a button from the list of quick entry buttons 744 (Normal, Positive, Low, and High), and such information (e.g., normal, positive, low, high) is automatically inputted into comments field. The “Con” column 701 enables a quick view associated conditions, the “Att” column 434 designates if attachments are associated to the field of information.

Treatments And Therapies (FIG. 7H);

The Treatments screen shown in FIG. 7H may be displayed by clicking on a Treatments icon 746. The Treatments screen allows a user to enter and review all treatments and therapies received and attach those treatments to specific problems. A user may review or edit a desired treatment from the list in table 748. For each treatment, a user may input a treatment name 750, a treatment code 752, a treatment date 754, and comments 756. The “Con” column 701 enables a quick view associated conditions, the “Att” column 434 designates if attachments are associated to the field of information.

Medications (FIG. 7I);

The Complete Medication History screen shown in FIG. 7I may be displayed by clicking on a Medicines icon 760. The Complete Medication History screen allows a user to record and review all medications prescribed for a user's family by doctors and all over-the-counter (OTC) medications family members are taking. A user may select a desired medication for review and edit it by choosing the medication name from the list displayed in table 762. For each medication, a user may enter a description of the medication in fields 764, including descriptions of the medication, the strength of the medication, the date prescribed, the number of refills, instructions on use of the medication, and the date the medication was filled. A user may also input comments about the medication in field 766, and indicate whether the medication was discontinued by entering the reason for the discontinuation and the date of discontinuation in fields 768. The user can choose to send selected information directly to the emergency card by selecting the checkbox labeled Include on Emergency Report 770. The “Con” column 701 enables a quick view associated conditions, the “Att” column 434 designates if attachments are associated to the field of information.

Immunizations and Vaccinations (FIG. 7J)

Keeping accurate immunization records is critical, especially for children and travelers. The Immunizations screen shown in FIG. 7J may be displayed by clicking on Immunizations icon 772. The Immunizations screen allows a user to record and review immunizations. For each immunization listed 773, a user may input a description of the immunization in field 774, the date it was given in field 776, who it was administered by in field 778, and include notes about the immunization in field 780. The user can choose to send selected information directly to the emergency card by selecting the checkbox labeled Include on Emergency Report 782. The “Att” column 434 designates if attachments are associated to the field of information.

Preventive And Miscellaneous Orders And Information (FIG. 7K)

The Preventative/Miscellaneous screen shown in FIG. 7K may be displayed by clicking on a Preventative/Misc. icon 784. This screen allows a user to record and review preventative orders and miscellaneous recommendations other than tests, treatments, or medications—such as an exercise program prescribed by a physician. For each preventive order and miscellaneous recommendation listed 786, a user may input a date in field 788, the type of preventative order or miscellaneous recommendation in field 790, details about the preventative order and miscellaneous recommendation in field 792, and comments in field 794. The “Con” column 701 enables a quick view associated conditions, the “Att” column 434 designates if attachments are associated to the field of information.

Medical Summary Tab

The Medical Summary tab 800 combines a users' complete longitudinal history of conditions, allergies, medications, tests, treatments, immunizations and preventive/miscellaneous interventions together on one screen using data stored on the Personal HealthKey 218 or other memory device 208. The PHR software application builds the summary automatically during the course of data entry elsewhere and cannot be created or edited by a user on this screen.

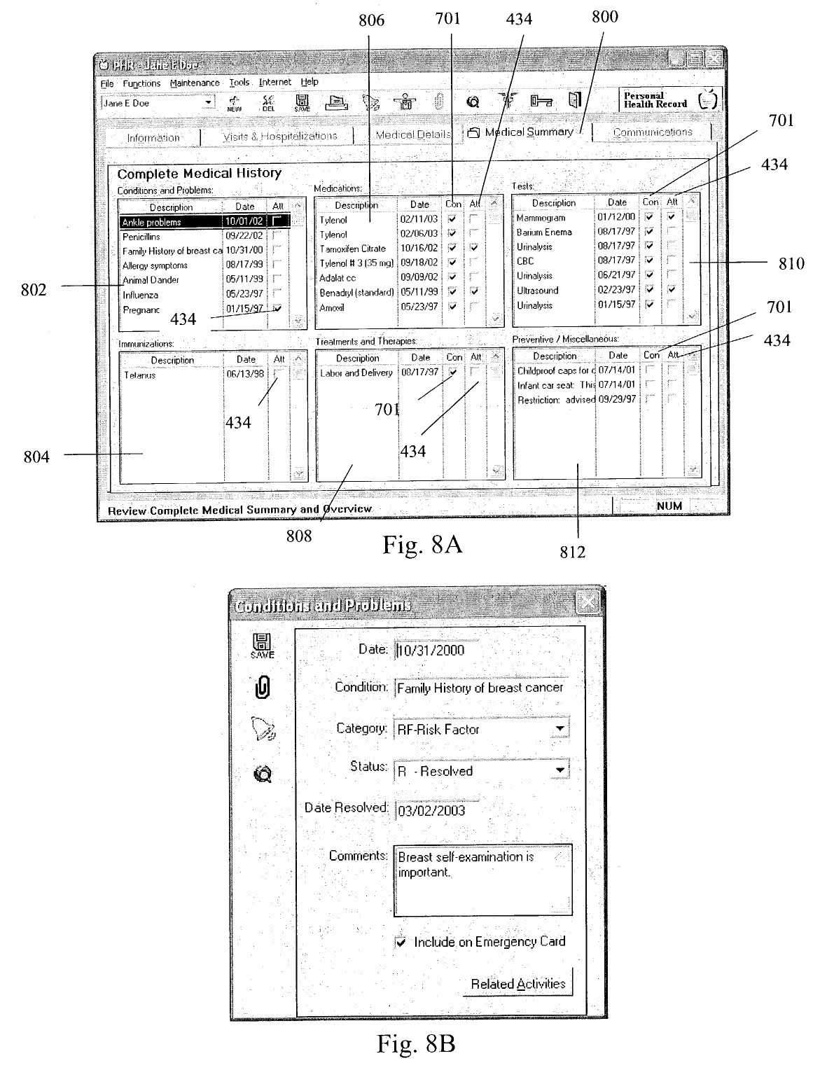

The complete medical history screen shown in FIG. 8A is displayed when a user selects Medical Summary tab 800. This screen displays lists of a user's Conditions and Problems in table 802, Immunizations in table 804, Medications in table 806, Treatments and Therapies in table 808, Tests in table 810, and Preventative/Miscellaneous in table 812. Double clicking an entry in any table opens a details window pertinent to that item, allowing a user to review the details of the selected item and examine useful relationships among the data or view attached images and documents, FIG. 8B. The “Con” column 701 enables a quick view associated conditions, and/or the “Att” column 434 designates if attachments are associated to the field of information.

Communications Tab

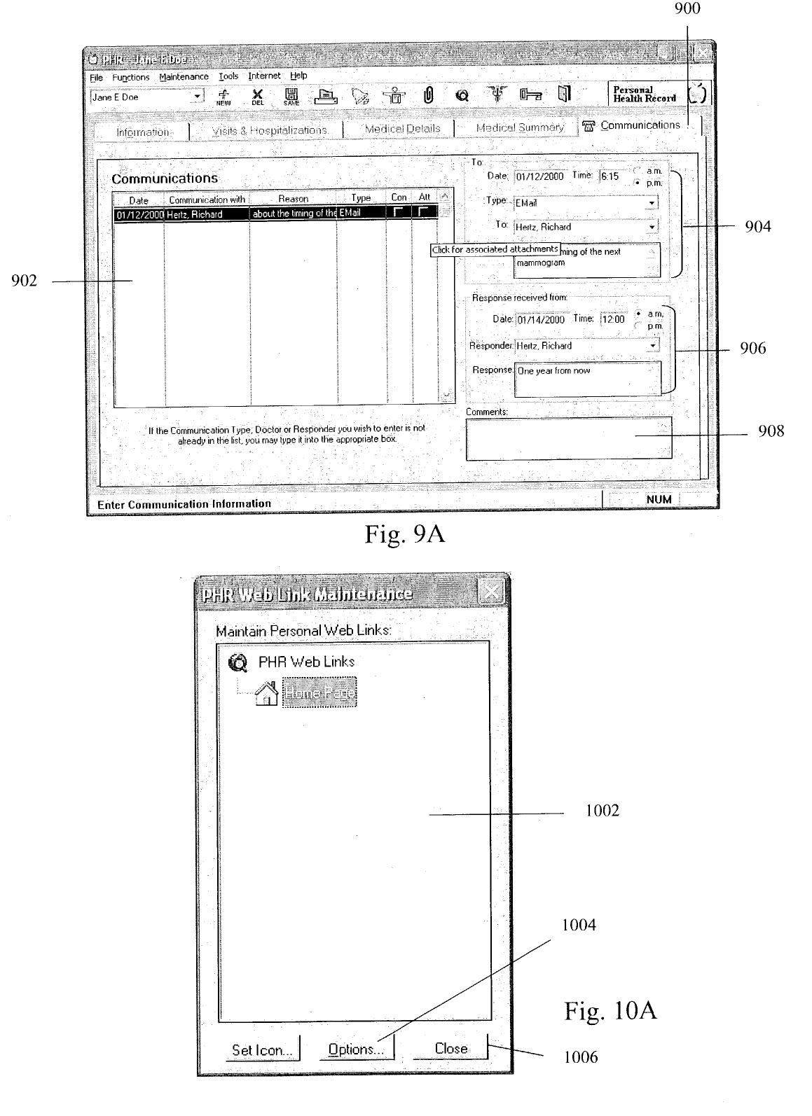

The Communications tab 900 opens the Communications screen, shown in FIG. 9A, which allows users to document and track communications with providers, insurers, and other significant medical contacts whether by mail, telephone, fax, or e-mail. Users can record the date, time, physician called, and reason for the communication, along with the date, time, responder and response to the communication. Users can also attach files and conditions or problems to each communication on the Communications tab. For example, a letter or e-mail may be attached to a communication. Information is viewable in table 902. Correspondence To information, which includes date, time, type of correspondence (Email, Fax, letter, telephone) are selectable from a drop down menu, and who the correspondence is with is selectable from a drop down menu, and comments section for reason are enable the user to record the call details 904. The user can record the contact response in the Response Received from that includes fields for date, time, responder, response 906. Comments can be recorded in 908.

The PHR software application makes it easy to take advantage of the numerous health-related sources found on the World Wide Web of the Internet. With the present invention, users can quickly open, add, and organize links to their favorite Web sites. These links can be stored on the Personal HealthKey 218 or other memory device 208 so that they are accessible wherever the user may need to access them. Doctors and hospitals may wish to distribute the software with links to their web sites pre-installed in the PHR software. However, users may add their own links to Web pages that enable them to find helpful information and organize those links into folders.

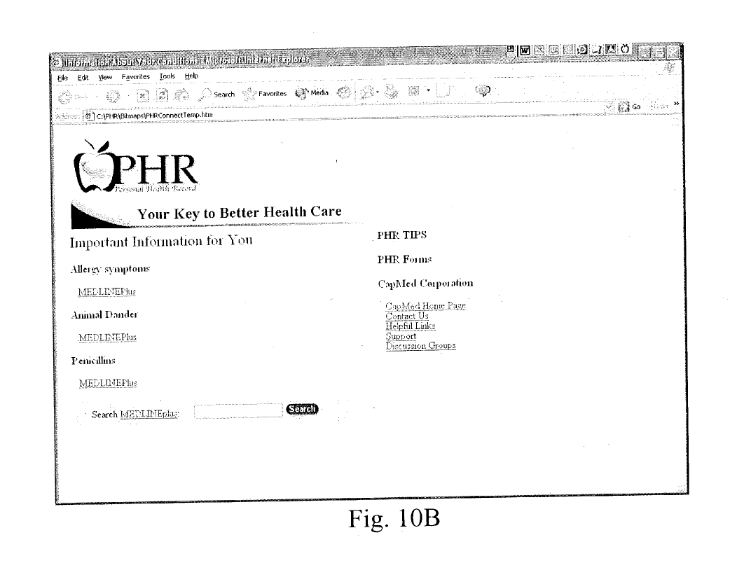

Users may review and edit their web links by selecting Web Link Maintenance from Maintenance dropdown menu 426. Once selected the PHR Web Link Maintenance screen is displayed as shown in FIG. 10A. This screen displays the default Web links and any user-input Web links in outline list box 1002, and also contains an Options button 1004 that enables the user to Add New Folder, Add New Link, Delete, Move, and Modify, and a Close button 1006. The outline list box 1002 contains the personal PHR Web Folders, Web Links, and preferred Home Page.

Selecting Home Page, FIG. 10B, enables the user to view a Personal Health Page that automatically builds based on available resources in PHR and user's specific needs.

Money Tab

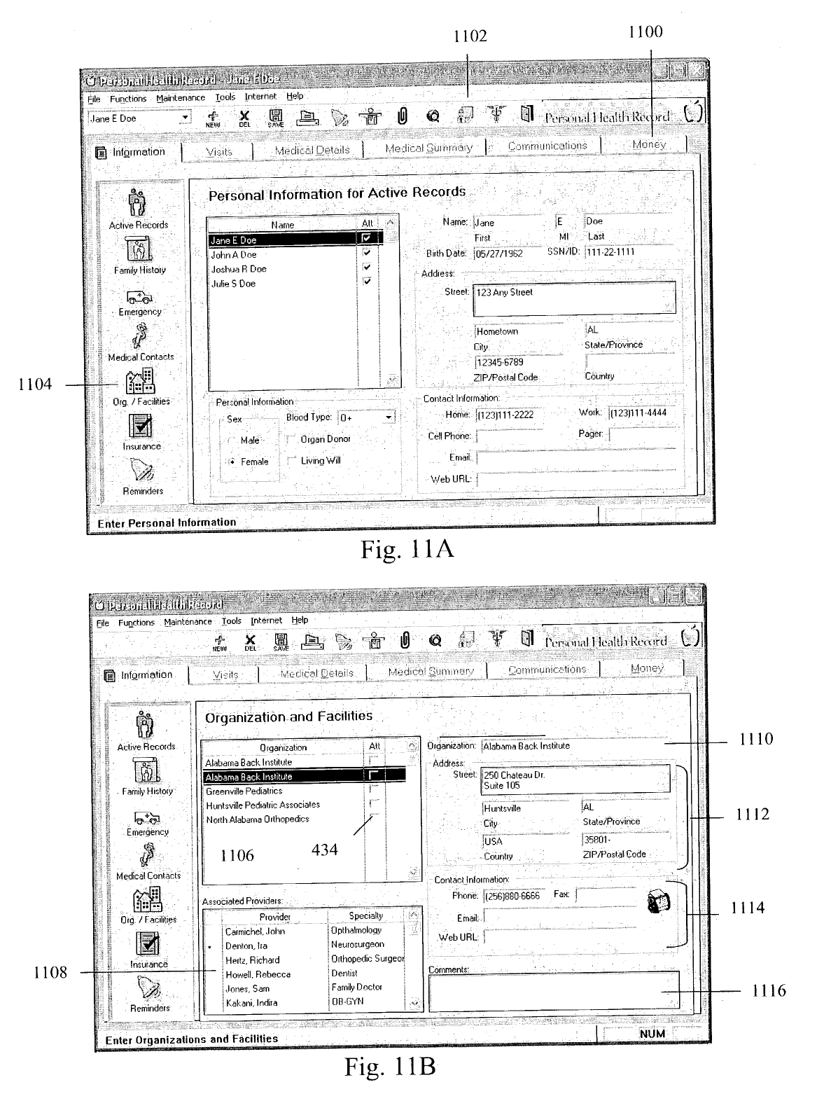

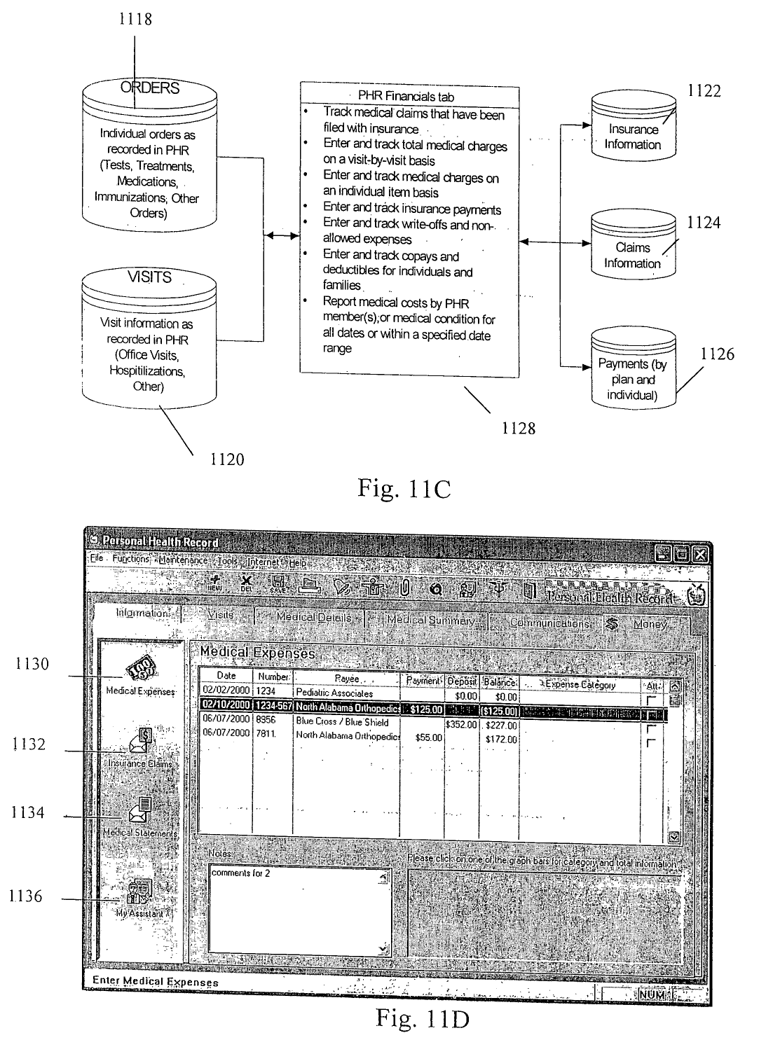

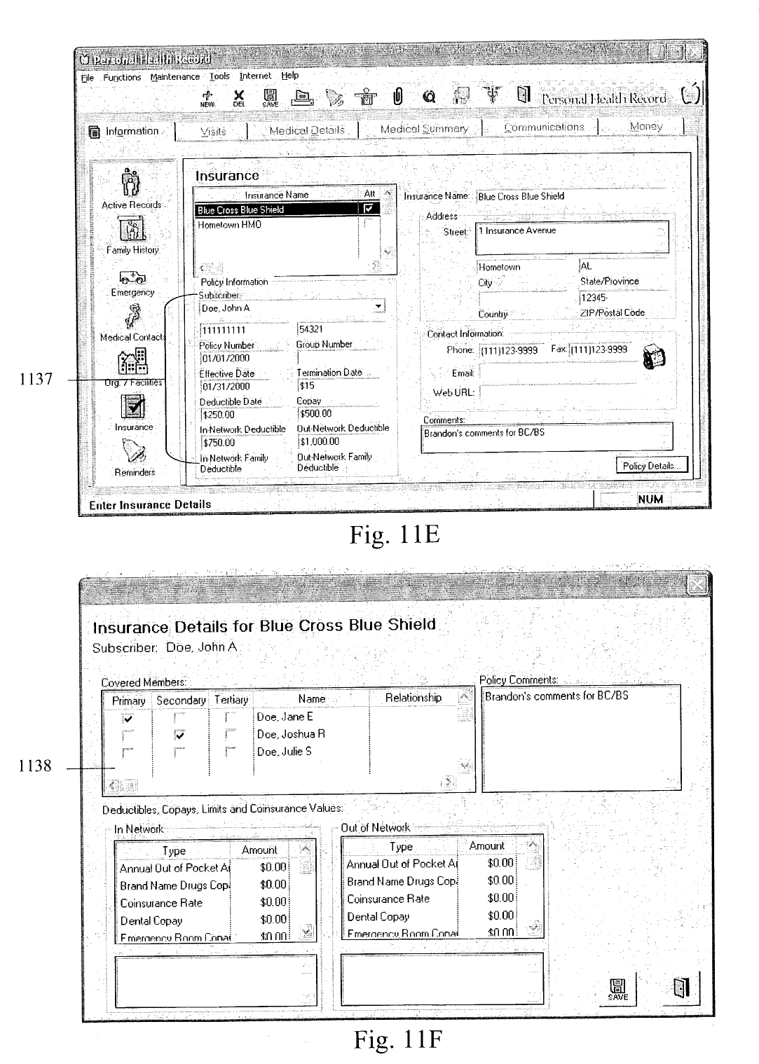

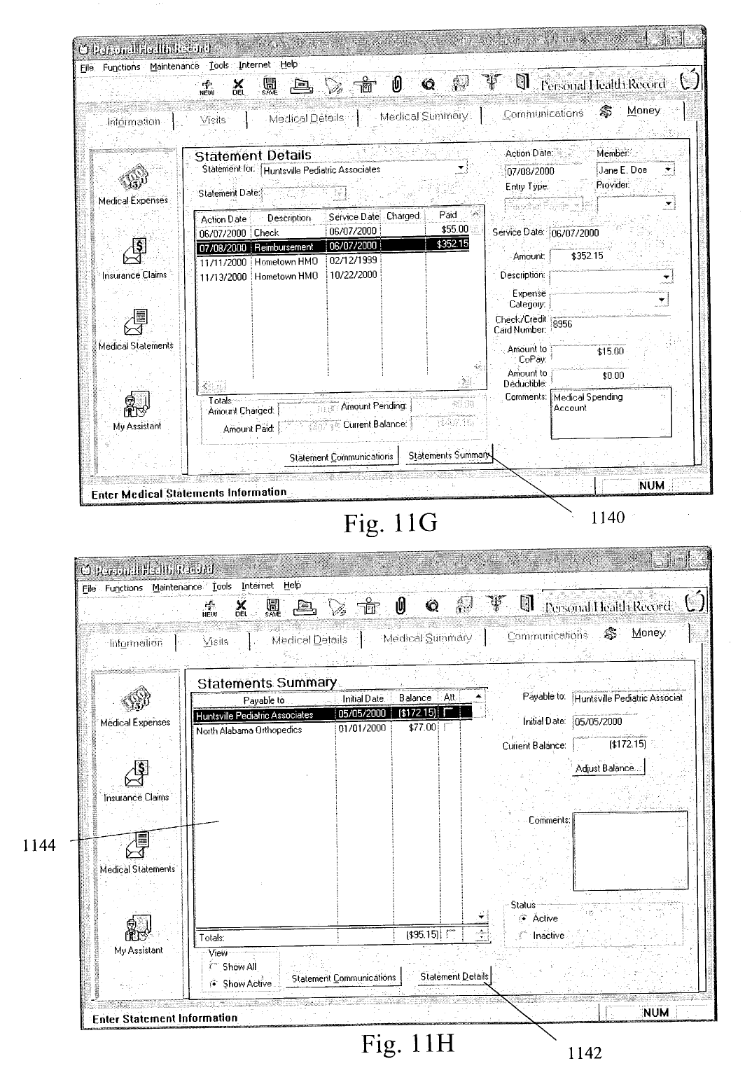

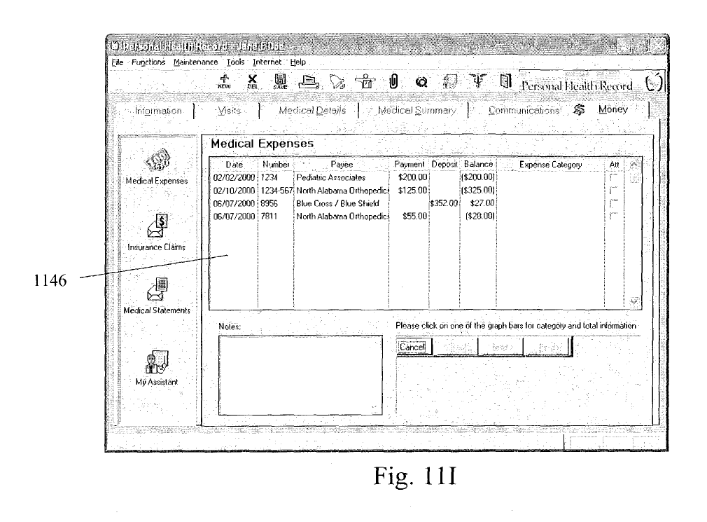

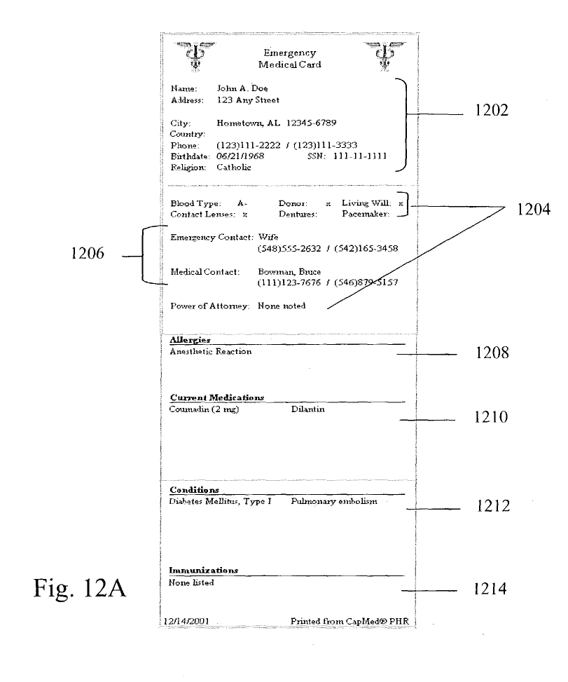

The Money tab 1100 may be used to enter and manage personal health care costs, especially out-of-pocket medical expenses, as shown in FIG. 11A. With the Money tab 1100, users can track the statements, claims, payments, and communications surrounding the financial side of their personal health care. The associated Wizard 1102, is a built in Assistant (a virtual assistant help software Wizard) to step the user through the process of chart entry. The Billing Organization icon 1104 enables the users to record and view healthcare-related facilities information. As shown in FIG. 11B, a user may capture information about billing organizations and facilities, such as clinics, hospitals, and other financial groups that handle billing for medical services and facilities 1106. Users can also associate providers with the appropriate billing organization 1108. For each billing organization, the user may input a name of the organization 1110, an address 1112, contact information 1114, and comments 1116. The “Att” column 434 designates if attachments are associated to the field of information.

As shown in FIG. 11C, individual orders 1118 and visit information 1120 are recorded and stored in Personal HealthKey storage device 218 or other memory device 208, as described previously. Insurance information 1122, medical claims information 1124, and payments 1126 (paid by an insurance plan(s) and by a user) are also stored in storage device 218.

With the Money tab 1100, medical information already entered in the Personal HealthKey 218 or other memory device 208 by the PHR software application can be associated with the appropriate financial information. As shown by reference numeral 1128, users can:

record charge amounts, account balances, and personal payments to medical providers;

manage insurance claim details, including allowable charges, amounts applied to deductibles, amounts paid to medical providers, and adjustments or write-offs made by medical providers;

obtain summaries and detailed reports for family members over a specified date range and by medical condition; and

enter and track medical expenses using an electronic check register.

As shown in FIG. 11D, available tabs for the user to track and manage healthcare expenses include Medical Expenses 1130, Insurance claims 1132, Medical Statements 1134, and My Assistance 1136.

The Money tab 1100 may also provide Internet access to insurance providers for automatic download of insurance information; the ability to include workman's compensation as a separate insurance coverage; the ability to differentiate between medical, vision, and dental insurance policies; the ability to import expense data from automated systems like Quicken or an online banking system; the ability to automatically update imported data or provide a match and post function; the ability to initiate credit card payments from within the PHR application; and the ability to specify billing organizations as participating or non-participating for each insurer.

Additional functions of the Money tab 1100 include:

The Expense Category command which allows users to modify the Expense Category maintenance list. Expense categories, such as Doctor's Fees, allow users to categorize medical expenses entered on the Money tab.

The Payment Method command, which allows users to customize the types of payments they can enter on the Money tab. These methods might include check, cash, Visa, MasterCard, and other methods of payment for medical expenses.

The Insurance Policy Detail Type command, which allows users to customize the types of details, they can enter for insurance policies, such as office visit co-pay and co-insurance rate.

The Insurance screen on the Information tab 500, FIG. 11E allows the user to enter additional information about insurance policies and their coverage details. The Insurance Policies screen, as shown in FIG. 11F, provides a place for users to enter and manage basic insurance policy information.

A Covered Members table 1138 identifies members and their coverage under a policy. Table 1138 includes Primary and Secondary columns that allow the user to indicate whether this policy is the primary or secondary insurance policy for the member.

A Policy Details table 1140 contains co-pays, deductibles, limits, and coinsurance values for in and out of network providers as covered under the insurance plan.

When a Statements icon 1134 of Money tab 100 is selected, a Statement Details screen, as shown in FIG. 11G, is displayed. The Statement Details screen shows the claims/EOBs and provides a summary of all claims entered for all family members, payors, and billing organizations. However, users can filter the display of claims in the table by clicking the View By button and defining display criteria. Claim information entered from the claims/EOBs tab is automatically added to the appropriate statement on the Statements tab.

When a Statements icon 1134 of Money tab 1100 is selected a Statement Summary screen as shown in FIG. 11H is shown. A user can switch between the Statement Details screen and the Statement Summary screen by selecting a button (e.g., Statement Summary 1140 shown in FIG. 11G or Details button 1142 shown in FIG. 11H). The Statements screens allow users to view existing statements, enter new statements, and enter charges, personal payments, and claim payments. Users can also record statement and claim contacts directly from the Statements screen. The Statements Summary screen includes a table 1144 that displays a list of all statements entered in the system.

When a user selects a Medical Expenses icon 1130 on the Money tab 1000, the Expenses screen is displayed as shown in FIG. 11I. The Medical Expenses screen is a check register that allows users to track personal medical payments and other healthcare related expenses and deposits. The Medical Expenses table 1144 allows users to enter and review their medical expenses. Users can enter medical expenses directly in the table.

Emergency Medical Card

The PHR software application also allows users to select critical information from their PHR records on the Personal HealthKey 218 or other memory device 208, and print this information as a foldable Emergency Medical Card that fits right in a user's in wallet. As a user's medical information changes, the user only has to print a new Emergency Card with the updated information.

As shown in FIG. 12A, the Emergency Card information includes: Personal Information 1202, such as a user's address, phone numbers, and identification (SSN, date of birth, sex, etc.); Additional Personal Information 1204, such as Organ Donor, Living Will, and Durable Power of Attorney for Health Care status, Blood Type, and Flags to identify if the member wears contact lenses, dentures, or has a pacemaker or a durable Power of Attorney; Contact Information 1206, such as Emergency Contact and Emergency Medical Provider; an Allergies List 1208; a Current Medications List 1210; a Current Conditions List 1212; and an Immunizations Status List 1214.

The PHR, or other, software application may be stored on storage device 208 or on the Portable HealthKey 218 of client entity 104, ensuring a secure environment. A user may run the software application directly from said storage device 208 or 218 of client entity to ensure the security of their medical records.

Alternatively and in accordance with another embodiment of the present invention, the PHR software application may be stored on a CD ROM portion of a combined CD ROM and credit card. The combined CD ROM and credit card of the present invention now makes possible storing the PHR software application on a CD ROM, while simultaneously providing a user with a credit card or other magnetic stripe card (e.g. identification or access card). This is a CD with format corresponding to that of a credit card (e.g., having the same size as a conventional credit card, approximately 3.375 inches by 2.125 inches), which can be inserted into a normal CD drive and read.

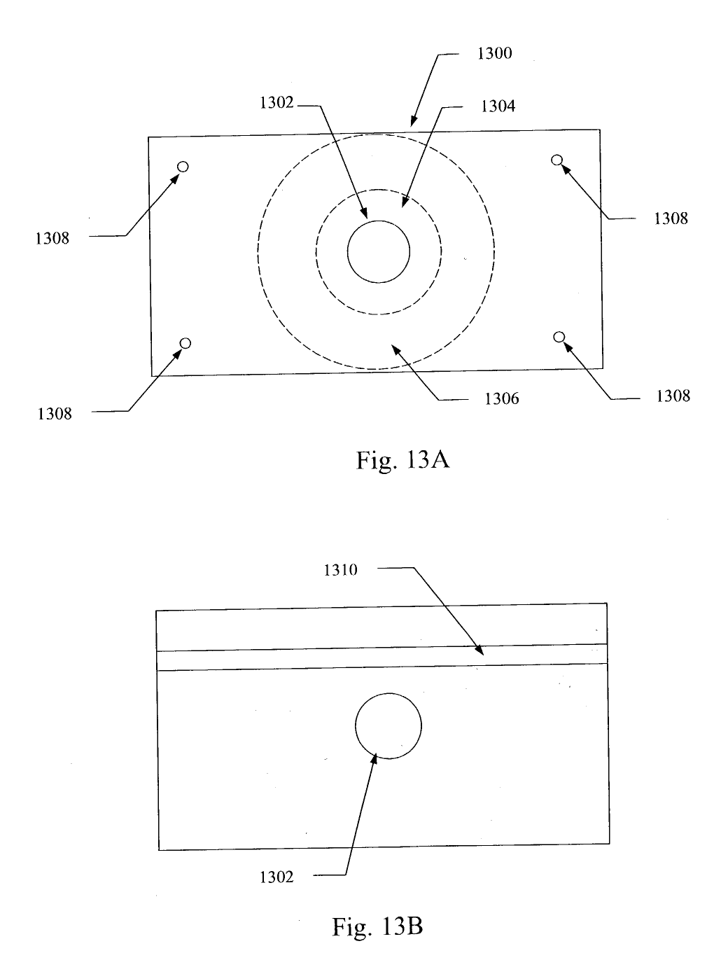

According to this invention, the credit card is designed as a CD-ROM in a credit card format and has suitable means for centering the credit card, designed as a CD-ROM, in the CD drive. A credit card in accordance with this invention is shown in FIG. 13A, in a bottom view, as reference numeral 1300. The credit card of this invention has a format, which is customary for credit cards. The credit card is made of the same material and in the same way as conventional CD ROMs. As shown in FIG. 13A, an opening 1302, which is bordered by a placement area 1304, is located in the center. Adjoining the placement area 1304 is the data area 1306, on which data, including the PHR software application, can be written and which can be read in the CD drive. A plurality of centering pins 1308, in this case preferably four, are arranged on a circle. The centering pins 1308 are arranged in such a way that, when the credit card is inserted into the CD drive, the centering pins 1308 rest against the centering shoulder of a CD drive, and maintain the credit card centered.

In an alternate embodiment the opening 1302 of the combined credit card and CD ROM 1300 may be filled with a chip to enable card 1300 to operate as a smart card, as disclosed in U.S. Pat. No. 5,569,741, the disclosure of which being incorporated herein by reference. Chip may include information regarding a user's medical records so that a user may provide his/her card 1300 to a physician during a visit and all of the user's pertinent medical records may be updated upon leaving the physician's office.

The top view of combined credit card and CD ROM 1300 is shown in FIG. 13B. The top of card/CD ROM 1300 includes a magnetic strip 1310 which may be encoded with information conventionally encoded on a credit card, e.g., account numbers, PIN codes, etc. This enables credit card companies to distribute the PHR software application and their credit card in one package, saving credit card companies the cost of distributing the two separately. A PHR software user may then apply for the credit card through the distributing credit card company and, once approved, have magnetic strip 1310 enabled by the credit card company.

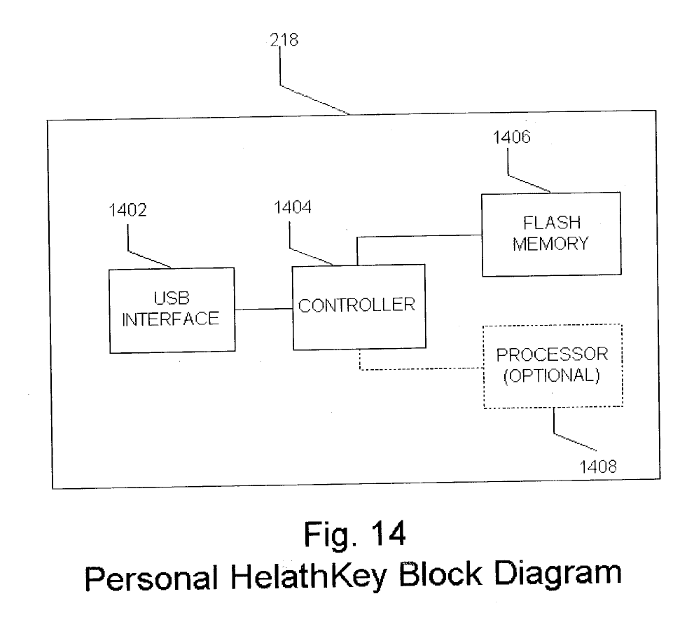

FIG. 14 shows an embodiment of the Personal HealthKey 218 in block diagram form. A universal interface 1402, such as a USB port, provides all connections with outside devices and draws power from said devices to operate the Personal HealthKey 218 when it is active. Said interface connects via a controller 1404 to the flash memory 1406 where information is stored and to an optional processor 1408 when implemented. The flash memory 1406 is capable of storing program code, which can be executed on the external computer device or on the on-board processor 1408. This processor when available can be used to sort and organize data and perform other operations on the data.

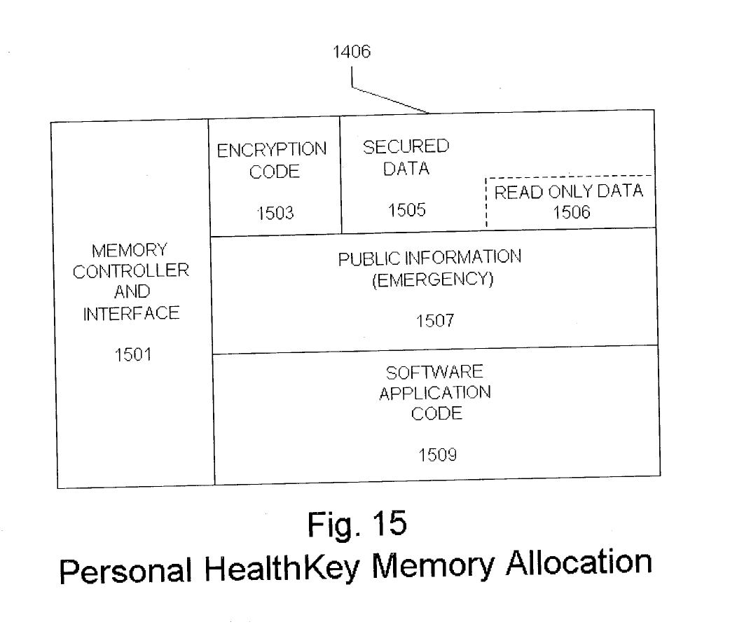

FIG. 15 provides an example of how memory can be allocated within the flash memory 1406. This is but one of a number of models for the memory allocation and is provided solely as an example. The Memory Controller and Interface 1501 controls all memory access operations. Encryption code 1503 limits access to the secured data 1505. The encryption algorithm may be executed on either the onboard processor 1408 or on the external host computer. Public information 1507 which includes the user's designated emergency information can be accessed directly via the memory controller 1501. Software application code 1509 is also available via the memory controller 1501. This application code can be launched automatically when the Personal HealthKey 218 is plugged into a suitable interface on a host computer or can be called Up and executed by the external host.

It is considered imperative in the healthcare world that medical records be tamperproof to assure accurate transmission of information from one provider to another and to prevent tragic errors. To assure accurate transmission of the data, the Personal HealthKey may be partitioned so that data received from an Electronic Medical Record or other data source and may be designated as read only by the data source. For this purpose a separate memory partition is set-aside in FIG. 15 for Secured Read Only Data 1506. The user may change data that he enters himself, but he may not change or alter data stored in partition 1506. The software may be implemented in such a fashion that read only data is displayed in a different color from changeable data.

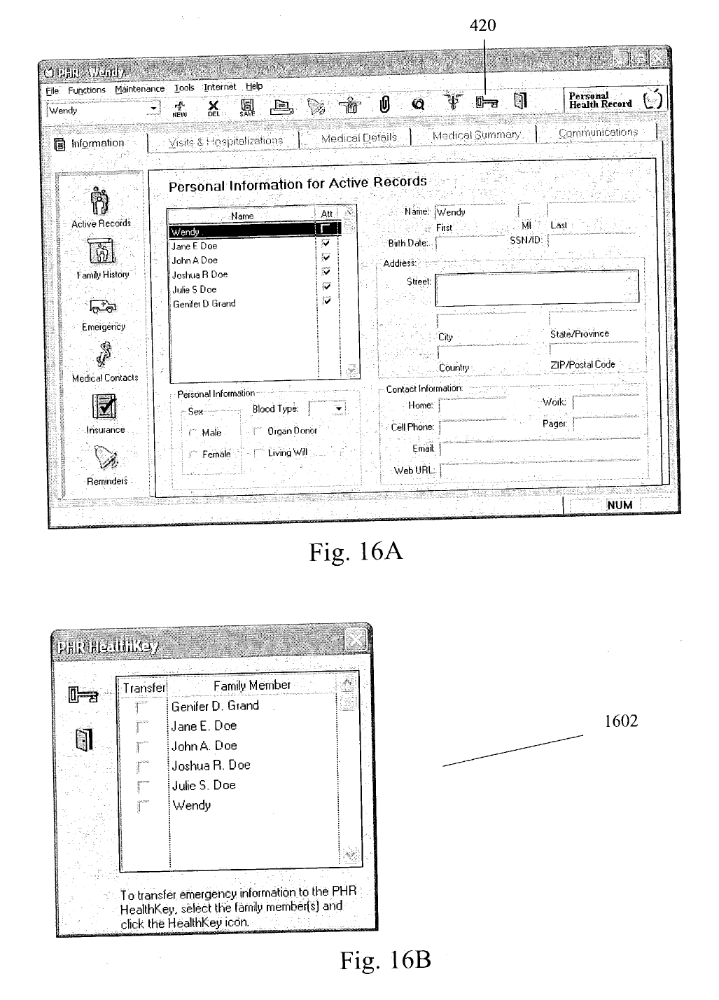

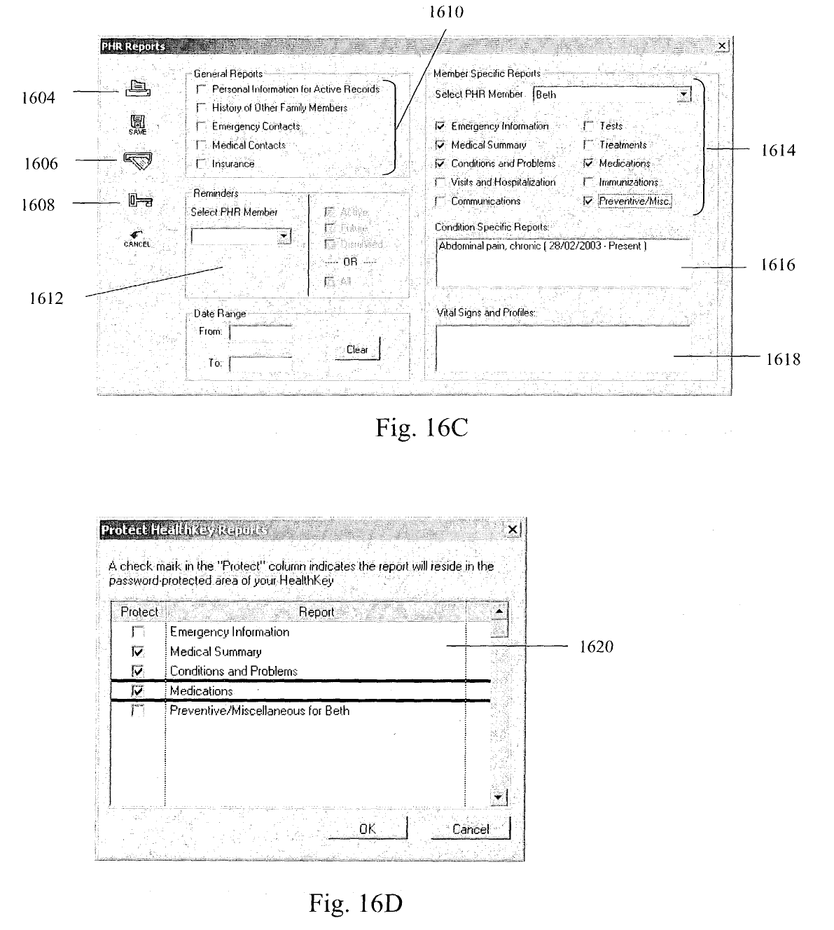

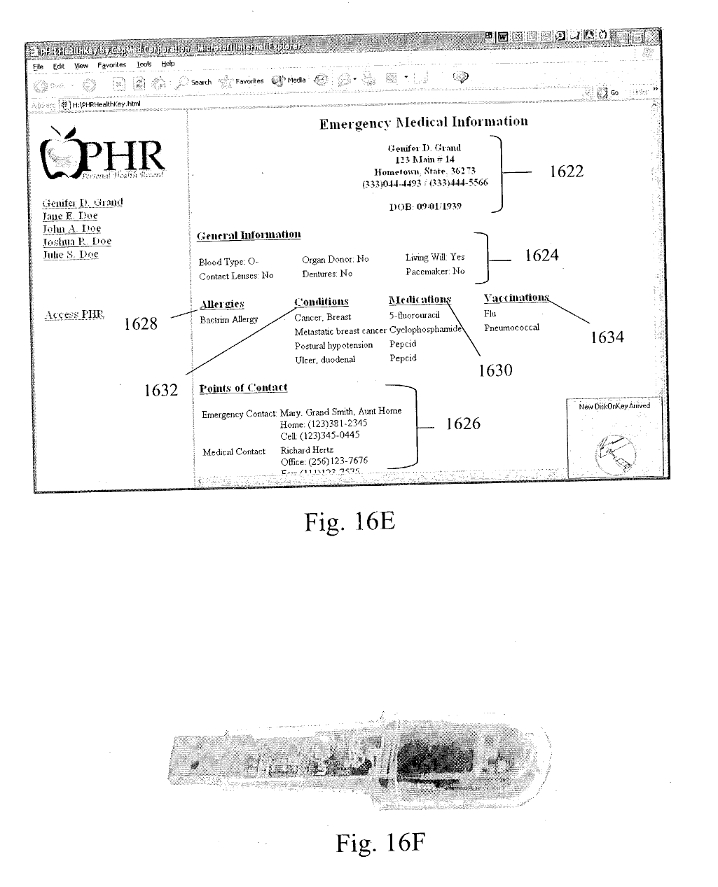

FIG. 16A demonstrates the option for a user to view or send information to the Personal HealthKey for available individuals. The user activates the Personal HealthKey by selecting the Key icon 420. FIG. 16B demonstrates the function of sending information to the key. Table 1602 enables the user to select which family member's information to send to the Personal HealthKey.

FIG. 16C demonstrates the Report Screen where the user can select which reports to generate for print 1604, email 1606, or to send to the Personal HealthKey 1608. The reports are generated from the Generate Reports screen 1610, including but not limited to Personal Information for Active Record, History of Family Members, Emergency Contacts, Medical Contacts, and Insurance information. Reminders can be viewed in the Reminders table 1612. Member specific reports can be generated by selecting the family member from the drop down menu and selecting the pertinent reports, Emergency Information, Medical Summary, Conditions and Problems, Visits and Hospitalizations, Communications, Tests, Treatments, Medications, Immunizations, and Preventive and Miscellaneous 1614. Condition specific reports can be viewed in the table 1616. Vital Signs and Profiles can be viewed in table 1618.

FIG. 16D demonstrates the table 1620 with which the user can designate which reports to send behind a password and which ones to leave in open architecture.

FIG. 16E demonstrates the emergency information page that auto launches when the Personal HealthKey is plugged into a USB port. Emergency information is selected by the user and includes: Personal Information 1622, such as a user's address, phone numbers, and identification (SSN, date of birth, sex, etc.); Additional Personal Information 1624, such as Organ Donor, Living Will, and Durable Power of Attorney for Health Care status, Blood Type, and Flags to identify if the member wears contact lenses, dentures, or has a pacemaker or a durable Power of Attorney; Contact Information 1626, such as Emergency Contact and Emergency Medical Provider; an Allergies List 1628; a Current Medications List 1630; a Current Conditions List 1632; and an Immunizations/Vaccination Status List 1634.

FIG. 16F demonstrates a sample of a USB flash-disk technology device.

The system of the present invention is preferably configured to permit a user of the device to identify what information to store and transport and whether to store securely or with open access. In addition, the system can included URLs or other network links which point to additional medical information which may be stored to permit accessing of said additional medical information. It is also preferred that a portion of memory in the programmable memory device is partitioned to be a “read only” memory.

The system preferably has the capability to interface with a plurality of information technology devices and medical test and diagnostic instruments for the purpose of exchanging data. Use of a USB flash memory device for storing, managing, transporting and communicating a plurality of personal health and medical information. The devices of the present invention can be, and preferably are, equipped with built in security to prevent access to specified memory areas. The devices can also be adjusted so that a portion of the memory is partitioned to be a “read only” memory. The programs in the memory devices can be selected and adapted to automatically launch when the memory device is inserted into a USB reader mechanisms and which permit immediate viewing of user designated emergency information from non-security protected regions of the memory.

The present system can use a USB flash memory device for storing, managing, transporting and communicating a plurality of personal health and medical information. This device can have built in security to prevent access to specified memory areas. More specifically, the device can have a portion of memory is partitioned to be a “read only” memory.

The present systems can also have programs residing in said memory device which will automatically launch when said memory device is inserted into a USB reader mechanisms and which permit immediate viewing of user designated emergency information from non-security protected regions of the memory.

Other embodiments of the invention will be apparent to those skilled in the art from consideration of this specification and practice of the invention disclosed herein. It is intended that the specification and examples be considered as exemplary only, with a true scope and spirit of the invention being indicated by the following claims.

We claim:

1. A system for securely storing, managing, transporting and communicating personal health records and medical information of a user comprising:
a. A non-volatile erasable and programmable memory device,
b. A means for recording information on said memory device,
c. A means for reading information from said memory device,
d. A program for managing information stored on said memory device and
e. Access security interlocks to prevent unauthorized access to certain areas of said memory device as designated by the user.

2. A system in accordance with claim 1 wherein the memory device is a flash memory device.

3. A system in accordance with claim 2 wherein the flash memory device is adapted to interface with the reading and writing means via standard USB ports.

4. A system of claim 1 comprising programs in said memory device which automatically launch when said memory device is inserted into a said means for reading, and wherein said programs permit immediate viewing of user designated emergency information from non-security protected regions of said memory.

5. A system of claim 1 further comprising at least one program in said memory device that facilitates the storage of a plurality of health and medical information on said memory device, said program being adapted to permit users to enter and update medical histories, records, tests results, or other information personally or via an interface option; and to communicate such information in full form or as useful reports.

6. A system of claim 1 wherein said information includes financial data.

7. A system of claim 1 wherein said medical information includes insurance data including coverage information, explanations of benefits and/or current billing and payment information.

8. A system of claim 1 wherein medical images are stored and transported on said memory device.

9. A system of claim 1 wherein said memory device is pocket or purse-sized.

10. A system of claim 1 adapted to permit a user to identify what information to store and transport on said memory device and whether to store the information securely or with open access.

11. A system of claim 1 wherein a portion of memory in said programmable memory device is designated and partitioned to be a “read only” memory.

12. A system of claim 1 adapted to interface with a plurality of information sources, such as the user, an institution, or technology devices and medical test and diagnostic instruments.

13. A system of claim 1 wherein the information includes medical records from at least one healthcare institution selected from a health system, laboratory company and clinical research organization.

14. A system of claim 1 wherein the memory device is adapted to encrypt, scramble or password protect stored data as directed by the user and/or the entity inputting the data.

15. A system of claim 14 with built in security to prevent access to specified memory areas.

16. A system of claim 1 wherein a portion of memory is partitioned to be a “read only” memory.

17. A system of claim 2 further comprising means in said memory device which will automatically launch when said memory device is inserted into a USB reader and adapted to permit immediate viewing of user designated emergency information from non-security protected regions of the memory.

18. A system of claim 17 adapted to exchange data with a plurality of information technology devices and medical test and diagnostic instruments.

19. A system of claim 17 wherein medical images are stored and transported on the device.

20. A system of claim 17 further comprising programs residing in said memory device which can encrypt, scramble or password protect stored data as directed by the user.

21. A system of claim 17 further comprising means to identify what information to store and transport and whether to store securely or with open access.

22. A system of claim 17 further comprising programs in said memory device that facilitate the storage of a plurality of health and medical information on said memory device, and which permit users to enter and update medical histories, records, tests results, or other information; and to communicate such information in full form or as abbreviated reports.

23. A system of claim 17 further comprising URLs or other network links which point to additional information may be stored to permit accessing of said additional information.

24. A system of claim 17 further comprising a smart card chip attached to the card, the smart card chip capable of performing arithmetic operations and retaining on-going records or balances.

25. A system of claim 17 with built in security to prevent access to specified memory areas.

26. A system of claim 17 further comprising a program in said memory device which will automatically launch when said memory device is inserted into a reader mechanism and which will permit immediate viewing of user designated emergency information from non-security protected regions of the memory.

27. A process for securely storing and retrieving health information comprising inputting health information; securely storing the health information; and retrieving the health information using a USB flash memory device.

28. A non-volatile memory device comprising:
a. a CD ROM which forms a base plastic card and which is readable and re-writeable;
b. a magnetic stripe affixed to the plastic card and which can be read by standard credit card readers.

29. A memory device of claim 28 further comprising a smart card chip attached to the card, the smart card chip being capable of performing arithmetic functions and retaining on-going records.

30. A memory device of claim 29 further comprising built in security to prevent access to specified memory areas.

31. A memory device of claim 28 further comprising programs which will automatically launch when said memory device is inserted into a reader mechanism and which permit immediate viewing of a user designated emergency information from non-security protected regions of the memory.

32. A memory device of claim 28 capable of interfacing with a plurality of information technology devices and medical test and diagnostic instruments.

33. A memory device of claim 28 further comprising programs which can encrypt, scramble or password protect stored data as directed by the user.

34. A memory device of claim 28 further comprising means for the user to identify what information to store and transport and whether to store securely or with open access.

35. A memory device of claim 28 further comprising programs that facilitate the storage of a plurality of health and medical information on said memory device, and which permit users to enter and update medical histories, records, tests results, or other information; and to communicate such information in full form or as abbreviated reports.
